(19) United States
(12) Patent Application Publication
(10) Pub. No.: US 2022/0353082 A1
(43) Pub. Date: Nov. 3, 2022

(54) Devices, Systems and Methods Relating to a Wearable Electronic Totem Device that Displays or Emits a Cryptographic Verification Code Including Real-World Corroborating Information to Discredit Later Generated Deepfake Media of the Wearer.

(71) Applicant: James David Busch, Tempe, AZ (US)

(72) Inventor: James David Busch, Tempe, AZ (US)

(21) Appl. No.: 17/733,976

(22) Filed: Apr. 29, 2022

Related U.S. Application Data
(60) Provisional application No. 63/181,872, filed on Apr. 29, 2021.

(51) Int. Cl. H04L 9/32; H04L 9/08; H04L 9/06; G06K 19/06

(52) U.S. Cl. CPC H04L 9/3226; H04L 9/0863; H04L 9/0643; H04L 9/3247; G06K 19/06037

(57) ABSTRACT

Devices, methods, and systems that thwart deepfake modification of media, and/or verify the identity of a person and that their communications have not been altered, among other applications. A device is configured to use sensors to record a corroborating data set (CDS) pertaining to the user in near real time. The CDS is encrypted or signed by a user's private key to create a cryptographic verification code (CVC). The CVC may be displayed, emitted, or otherwise distributed by the totem device. Alternatively, the CVC may be superimposed or embedded as metadata in media produced by the device. The CVC cannot be modified with deepfake techniques while image and video data may be modified with deepfake techniques. Analysis of media containing a CVC can confirm whether the CVC is authentic, and whether the CDS contained within is consistent with the depiction of the user in the media.

### CROSS REFERENCE TO RELATED APPLICATIONS

This application claims the benefit of U.S. Provisional Application 63/181,872 filed Apr. 29, 2021, which is herein incorporated by reference in its entirety.

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

REFERENCE TO A “SEQUENCE LISTING,” A TABLE, OR A COMPUTER PROGRAM LISTING APPENDIX SUBMITTED AS AN ASCII TEXT FILE

The official copy of the computer program listing appendix is submitted as an ASCII formatted text file via EFS-Web, with a file name of “BITTOTEM_CODE_LISTING.txt”, a creation date of Apr. 29, 2022, and a size of 86762 bytes. The computer program listing filed via EFS-Web is part of the specification, is incorporated in its entirety by reference herein.

### BACKGROUND

### 1. Field of the Invention

This invention generally relates to methods and systems that indicate whether an image, audio recording, video, or other media has been modified by deepfake media modification techniques. More specifically, this invention relates to methods and systems for recording corroborating data sets, encrypting or signing the corroborating data or a reference to the data to create a cryptographic verification code, and then emitting, displaying, embedding or otherwise coupling the cryptographic verification code to the media. While the media may be modifiable using deepfake techniques, the cryptographic verification code cannot be modified. A mismatch between the media and the data contained or referenced by the cryptographic verification code may indicate that the media has been modified and is not reliable. Numerous additional applications and features are also discussed herein. For example, once a media item is verified as reliable, social media permissions, licensing, media manipulation, and other user-facing features are possible based on the verification of the media item.

In the movie Inception, Dom Cobb (played by Leonardo DiCaprio) is a thief with the ability to enter people's dreams and steal their secrets from their subconscious. The dreams are so convincing to the victim that they could not distinguish them from reality.

Similarly, deepfake media is becoming more common, and will cause problems as people try to distinguish these deepfake media items from reality. Deepfakes could become so convincing that they will be, essentially, indistinguishable from reality. See, e.g., Cite No. D0076.

In addition, the methods for creating deepfakes may become so simple that convincing forgeries can be created with next to zero effort and on a whim by anyone. Currently, convincing deepfakes may be created by relatively sophisticated software such as DeepFaceLab. According to its GitHub page: “More than 95% of deepfake videos are created with DeepFaceLab.” Cite No. D0003.

Much easier to use software—with less convincing results—is also currently available to anyone with a smart phone. Mobile phone applications such as “Avatarify” make creating a deep fake video as easy as selecting a picture of a target individual, and then recording a selfie video saying whatever you wish to have the target person say.

Soon anyone will be able to simply ask a service to prepare a rendition of a media item where a target subject says or does anything that the requesting person desires.

Deepfake media may further fuel alleged “fake news” and “cancel culture” which have become a problem for society and individuals alike. To the extent deepfake media items are so compelling and indistinguishable from reality, nefarious actors may create deepfake media to influence world events with “fake news” and “cancel” individuals for personal and political reasons.

For example, in the fictional TV Show “The Capture,” a former United Kingdom Special Forces Lance Corporal finds himself accused of the kidnapping and murder of a woman. The only evidence tying him to the crime is a damning deepfake CCTV video falsely showing him forcefully taking the victim from a bus stop. The reality was that he parted ways with her, and she got on the bus. Later, the victim was kidnapped from her home and murdered by other people. See, e.g., Cite No. D0007.

There is a need for a way to identify deepfake media and verify whether a person depicted in a media is authentic, and whether the circumstances depicted in the media actually occurred as depicted.

In the movie Inception, a totem was used to help the movie protagonists know whether they were in their own reality or someone else's reality:

“A [t]otem is an object that is used to test if oneself is in one's own reality (dream or non-dream) and not in another person's dream. A totem has a specially modified quality (such as a distinct weight, balance, or feel) in the real world, but in a dream of someone who does not know it well, the characteristics of the totem will very likely be off. Any ordinary object which has been in some way modified to affect its balance, weight, or feel will work as a totem.”

Cite No. D0001.

One defining characteristic of a totem is that it has a unique aspect or special characteristic that is known only to the person that it belongs to. For example, Arthur (played by Joseph Gordon-Levitt) described his totem, a set of dice with a particular weight distribution:

“I can't let you touch it, that would defeat the purpose. See only I know the balance and the weight of this particular loaded die. That way, when you look at your totem, you know beyond a doubt that you're not in someone else's dream.”

Cite No. D0001. Commentators have emphasized, however, that totem devices are mere fiction:

In Inception, your totem supposedly can assure you that you're not in a dream. But unfortunately, elegant though this “solution for keeping track of reality” may be, it's ineffective outside the fictional world of that movie. (Just in case you were in doubt.)

Cite No. D0091.

In short, a totem is “an elegant solution for keeping track of reality.” Unfortunately, the ones that exist in Inception are fictional and—even as depicted in the film—would not prevent deepfake videos.

There is a need for a “totem” device that can protect its owner from being manipulated in deepfake media content, and the public from being deceived by deepfake media.

While media may be convincingly generated or modified by computers using deepfake techniques, forms of public/private key cryptography cannot be broken by the world's most powerful computers.

Collect Corroborating Data. First, there is significant benefit provided by devices, systems and methods that collect corroborating data about an owner/wearer of a totem at a specific time.

This may be accomplished by, for example, using sensors to collect corroborating information about the wearer/owner of a device and the environment in (near) real time. Such information may relate to the orientation of the totem device, nearby sounds (e.g., frequency spectrum history, audio volume history, and/or speech to text transcription, etc.) and/or other information may be collected as corroborating information.

Cryptographically Secure the Corroborating Data. Second, there is significant benefit provided by devices, systems and methods that encode, encrypt and/or sign this corroborating data in a way that only the owner of the totem can (using a secret private key), but that anyone can decode and/or verify.

This may be accomplished by a unique cryptographic verification code that encodes the corroborating information. The cryptographic verification code is secured with the wearer's private cryptographic key. The information is either encrypted, signed and/or both.

Broadcast the Cryptographically Secured Corroborating Data for Capture in Third-Party Media. Third, there is significant benefit provided by devices, systems and methods that broadcast the encoded signed or encrypted corroborating data in such a way that it is captured by third party recording devices.

This may be accomplished by, for example, displaying, (sub-)audibly emitting or otherwise distributing the cryptographic verification code from the device. This provides corroborating information in a format that is captured in media and cannot be accurately imitated, faked, or reproduced in deepfake or other modified media.

Extract the Cryptographically Secured Corroborating Data from the Third-Party Media. Fourth, there is significant benefit provided by devices, systems and methods that extract the cryptographic verification codes from third-party media.

This may be accomplished, for example, by processing the media frames or soundtracks for encoded cryptographic verification codes.

Verify the Extracted Cryptographically Secured Corroborating Data. Fifth, there is significant benefit provided by devices, systems and methods that verify cryptographic verification codes extracted from third-party media are authentic (e.g., cryptographically secure, signed properly, etc.).

This may be accomplished, for example, by using a cryptographic signature along with the message or message hash to obtain a public key of the actual signer of the message (if properly signed and the message is not tampered) and comparing that public key with the purported signer's public key.

When viewing the media, the cryptographic verification code may be extracted. The cryptographic signature can be verified and/or the information decrypted using the purported subject's public key.

The public key of the purported wearer may be obtained from a trusted source such as a smart contract, an online identity database, social media, a verified website associated with the purported wearer, etc. The authenticity of the totem/device and generated code can be determined.

Compare the Content of the Media to the Cryptographically Secured Corroborating Data. Sixth, there is significant benefit provided by devices, systems and methods that compare the extracted verified cryptographically secure corroborating information against the content the media is depicting.

For example, the encoded corroborating information may be extracted from the verified cryptographic verification code extracted from the media. The media that is under scrutiny can be analyzed to determine if the depiction is consistent with the corroborating information. The authenticity of the depiction in the media can be determined. Based on the analysis, the authenticity of the identity of the purported subject and the content of the media may be verified or flagged as a deepfake or modification.

Is the video you are watching merely a dream that someone wants to place you into for their own personal or political objectives? With the present disclosure, the world will be able to answer that question and determine if the information depicted in the media depicts reality or is a deepfake modification of reality.

### DESCRIPTION OF RELATED ART

So as to reduce the complexity and length of the Detailed Specification, and to fully establish the state of the art in certain areas of technology, Applicant(s) herein expressly incorporate(s) by reference all of the following materials identified in each numbered paragraph below.

For more information on “Totems” as depicted in the movie Inception, see, for example: Cite Nos. D0001 and D0091.

For more information on “deepfake” media manipulation, see, for example: Cite Nos. A0003-A0011, B0001-B0037, D0002-D0009, D0076, D0083-D0085.

For more information on wearable, mobile, and/or secure electronic devices, see, for example: Cite Nos. D0010-D0020.

For more information on the TTGO T-Watch 2020 V3 used to construct a prototype proof of concept device depicted herein, see, for example: Cite Nos. D0021-D0026.

For more information on images that can encode information, see, for example: Cite Nos. A0001-A0002, and D0027-D0036.

For more information on audio analysis see, for example: Cite Nos. D0037-D0040.

For more information on audible and sub-audible encoding of information, see, for example: Cite Nos. D0041-D0045.

For more information on hashing, see, for example: Cite Nos. D0046-D0047, and D0082. (Note that KECCAK256 is a variant of SHA-3 that uses 0x01 padding instead of 0x06.)

For more information on cryptography, encryption, and message signing, see, for example: Cite Nos. D0048-D0061, and D0075.

For more information on cryptocurrency and blockchain technology, see, for example: Cite Nos. D0062-D0072, and D0086-D0087.

For more information on smart contracts and non-fungible tokens, see, for example: Cite Nos. A0012, D0076-D0079, and D0090.

For more information on distributed file storage see, for example: Cite Nos. D0073, D0074.

For more information on multi-factor authentication see, for example: Cite Nos. D0080 D0081.

For more information on web client development see, for example: Cite Nos. D0088 D0089.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### SUMMARY OF THE INVENTION

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts in defining the claimed invention. The inventor is fully aware that he can be his own lexicographer if desired. The inventor expressly elects, as his own lexicographers, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of post-AIA 35 U.S.C. § 112(f). Thus, the use of the words “function,” “means” or “step” in the Detailed Description or Description of the Drawings or claims is not intended to somehow indicate a desire to invoke the special provisions of post-AIA 35 U.S.C. § 112(f), to define the claimed invention. To the contrary, if the provisions of post-AIA 35 U. S.C. § 112(f) are sought to be invoked to define the claimed inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of post-AIA 35 U.S.C. § 112(f). Moreover, even if the provisions of post-AIA 35 U.S.C. § 112(f) are invoked to define the claimed inventions, it is intended that the claimed inventions not be limited only to the specific structure, material or acts that are described in the preferred embodiments, but in addition, include any and all structures, materials or acts that perform the claimed function as described in alternative embodiments or forms of the claimed invention, or that are well known present or later-developed, equivalent structures, material or acts for performing the claimed function.

The aspects, features, and advantages will be apparent to those artisans of ordinary skill in the art from the DETAILED DESCRIPTION and DRAWINGS, and from the CLAIMS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1A depicts one form of an example block diagram of a totem device in accordance with the disclosure.

FIG. 1B depicts one form of an example block diagram of a remote system device in accordance with the disclosure.

FIG. 1C depicts one form of an example diagram for a connection between a totem device and a remote system in accordance with the disclosure.

FIG. 1D depicts one form of an example system diagram utilizing an Ethereum smart contract to assist with the totem verification process in accordance with the disclosure.

FIG. 2A depicts one form of an example wristwatch totem device form factor in accordance with the disclosure.

FIG. 2B depicts one form of an example glasses totem device form factor in accordance with the disclosure.

FIG. 2C depicts one form of an example hat totem device form factor in accordance with the disclosure.

FIG. 2D depicts one form of an example necklace totem device form factor in accordance with the disclosure.

FIG. 2E depicts one form of an example totem device form factor on a mobile device in accordance with the disclosure.

FIG. 2F depicts one form of an example plaque totem device form factor in accordance with the disclosure.

FIG. 2G depicts one form of an example lapel pin totem device form factor in accordance with the disclosure.

FIG. 3A depicts one form of an example totem device setup method in accordance with the disclosure.

FIG. 3B depicts one form of an example totem device main loop method flowchart in accordance with the disclosure.

FIG. 3C depicts one form of an example totem device corroborating data set (CDS) creation method flowchart in accordance with the disclosure.

FIG. 3D depicts one form of an example cryptographic verification code (CVC) creation method flowchart in accordance with the disclosure.

FIG. 4 depicts one form of an example corroborating data set (CDS) and CDS chain in accordance with the disclosure.

FIG. 5A depicts one form of an example CVC/CDS verification method flowchart in accordance with the disclosure.

FIG. 5B depicts one form of an example CVC/CDS corroborating data set verification method flowchart in accordance with the disclosure.

FIG. 5C depicts one form of an example media attribute feature analyzer in accordance with the disclosure.

FIG. 5D depicts one form of an example media analyzer in accordance with the disclosure.

FIG. 6A depicts one form of an example verification of a CVC/CDS using a mobile device in accordance with the disclosure.

FIG. 6B depicts one form of an example verification analysis of audio and motion data contained in a CVC/CDS against an associated media item in accordance with the disclosure.

FIG. 7A depicts one form of an example totem device (working prototype) displaying a CVC/CDS and being scanned by a mobile device with a QR code scanning application in accordance with the disclosure.

FIG. 7B depicts one form of an example decoded CVC from the example totem device of FIG. 7A (working prototype) including a CDS and cryptographic signature in accordance with the disclosure.

FIG. 7C depicts one form of an example successful cryptographic signature verification of the CVC/CDS (from FIGS. 7A-B) using a public Ethereum message verification website in accordance with the disclosure.

FIG. 7D depicts one form of an example a custom web site interfaced with a smart contract backend in accordance with the disclosure that is configured to scan a CVC barcode and allow a user to verify the CVC.

FIG. 7E depicts one form of an example a custom web site interfaced with a smart contract backend in accordance with the disclosure in a state after scanning a CVC barcode and allow a user to verify the CVC, but before the CVC has been submitted for verification.

FIG. 7F depicts one form of an example successful cryptographic signature verification of the CVC/CDS (from FIGS. 7A-B) using a custom website interfaced with a smart contract backend in accordance with the disclosure.

FIG. 7G depicts one form of an example unsuccessful cryptographic signature verification of a modified CVC/CDS (from FIGS. 7A-B) using a custom website interfaced with a smart contract backend in accordance with the disclosure.

The figures are provided to aid in the understanding of the disclosure and any specifically claimed invention. The simplicity of the figures should not use to limit the scope of the claimed invention.

Elements and acts in the figures are illustrated for simplicity and have not necessarily been rendered according to any particular sequence or embodiment, and their simplicity should not use to limit the scope of the claimed invention.

### DETAILED DESCRIPTION

In the following description, and for the purposes of explanation, numerous specific details are set forth in order to provide a thorough understanding of the various aspects of the claimed invention. The disclosure is of course, broader than the claimed invention and is believed to contain numerous different inventions in various forms. The present disclosure describes matter, which may (in this application or a continuing application) be claimed as an invention. It will be understood, however, by those skilled in the relevant arts, that the claimed invention may be practiced without these specific details. In other instances, known structures and devices are shown or discussed more generally in order to avoid obscuring the claimed invention. In many cases, a description of the operation is sufficient to enable one to implement the various forms of the claimed invention, particularly when the operation is to be implemented in software. It should be noted that there are many different and alternative configurations, devices and technologies to which the disclosure may be applied, and which may (in this application or a continuing application) be claimed as an invention. The full scope of the disclosure which may (in this application or a continuing application) be claimed as an invention, is not limited to the examples that are described below.

Among those benefits and improvements that have been disclosed, other objects and advantages of the disclosure will become apparent from the following description taken in conjunction with the accompanying figures. Detailed forms of devices, systems and methods are disclosed herein; however, it is to be understood that the disclosed forms are merely illustrative of the numerous inventions contained in the disclosure, which may (in this application or a continuing application) be claimed as an invention, which may be embodied in various forms. in addition, each of the examples given in connection with the various forms of the devices, systems and methods disclosed which are intended to be illustrative, and not restrictive.

The subject matter regarded as the invention in the present application is particularly pointed out and distinctly claimed in the CLAMS. The invention, however, both as to organization and method of operation, together with any provided objects, features, and advantages thereof, may best be understood by reference to the following detailed description when read with the accompanying drawings.

The figures constitute a part of this specification and include illustrative forms of the disclosed devices, systems and methods, which may (in this application or a continuing application) be claimed as an invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the disclosed devices, systems and methods. Further, where considered appropriate, reference numerals may be repeated among the figures to indicate corresponding or analogous elements.

Because the illustrated forms of the disclosed devices, systems and methods may for the most part, be implemented using electronic components and circuits known to those skilled in the art, details will not be explained in any greater extent than that considered necessary, for the understanding and appreciation of the underlying concepts of the present disclosure and in order not to obfuscate or distract from the teachings of the present disclosure. However, various example implementations may be provided to illustrate some of the many forms in Which devices, systems and methods implementing the disclosure may take.

Any reference in the specification to a method should be applied mutatis mutandis (with any necessary changes) to a system capable of executing the method. Any reference in the specification to a system should be applied mutatis mutandis to a method that may be executed by the system.

Throughout the specification and claims, the following terms take the meanings explicitly associated herein, unless the context clearly dictates otherwise. The phrases “in one embodiment,” “in one form.,” “in an example embodiment,” “in an example form,” “in some embodiments,” “in some forms,” and other similar phrases as used herein do not necessarily refer to the same embodiment(s) or form(s), though it may. Furthermore, the phrases “in another embodiment,” “in another form,” “in an alternative embodiment,” “in an alternative form,” “in some other embodiments,” and “in some other forms” or similar phrases as used herein do not necessarily refer to a different embodiment or form, although it may. Thus, as described below, various forms of the devices, systems and methods disclosed herein may be readily combined, without departing from the scope or spirit of the disclosure which may (in this application or a continuing application) be claimed as an invention.

The use of the word “coupled” or “connected” implies that the elements may be directly connected or may be indirectly connected or coupled through one or more intervening elements unless it is specifically noted that there must be a direct connection.

In addition, as used herein, the term “or” is an inclusive “or” operator and is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

As will be appreciated by one skilled in the art, the present disclosure describes matter, which may (in this application or a continuing application) be claimed as an invention, may be embodied as a system, method, computer program product or any combination thereof. Accordingly, this matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this matter takes the form of a computer program product embodied in any tangible medium of expression having computer usable program code embodied in the medium.

The present disclosure describes matter, which may (in this application or a continuing application) be claimed as an invention, may be described in the general context of computer-executable instructions, such as program modules, being executed by a computer. Generally, program modules include routines, programs, objects, components, data structures, etc. that perform particular tasks or implement particular abstract data types. The matter may also be practiced in distributed computing environments where tasks are performed by remote processing devices that are linked through a communications network. In a distributed computing environment, program modules may be located in both local and remote computer storage media including memory storage devices.

Any combination. of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with the instruction execution system, apparatus, or device.

Computer program code for carrying out operations of the present disclosure may be written in any combination of one or more programming languages, including any language suitable for programming smart contracts on any crypto blockchain such as Solidity, an object-oriented programming language such as Java, Smalltalk, C++, C# or the like, conventional procedural programming languages, such as the “C” programming language, and functional programming languages such as Prolog and Lisp, machine code, assembler or any other suitable programming languages. The program code may execute entirely on the user's computer, partly on the user's computer, as a. stand-alone software package, partly on the user's computer and partly on a remote computer or entirely on the remote computer or server. in the latter scenario, the remote computer may be connected to the user's computer through any type of network using any type of network protocol, including for example a local area network (LAN) or a wide area network (WAN), or the connection may be made to an external computer (for example, through the Internet using an Internet Service Provider).

The present disclosure describes matter, which may (in this application or a continuing application) be claimed as an invention, is described below with reference to flowchart illustrations and/or block diagrams of methods, apparatus (systems) and computer program products according to various forms of the disclosed devices, systems and methods. It will be understood that each block of the flowchart illustrations and/or block diagrams, and combinations of blocks in the flowchart illustrations and/or block diagrams, can be implemented or supported by computer program instructions. These computer program instructions may be provided to a processor of a general-purpose computer, special purpose computer, microcontroller, or other programmable data processing apparatus to produce a machine, such that the instructions, which execute via the processor of the computer or other programmable data processing apparatus, create means for implementing the functional/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block being or blocks.

The blockchain used by any form of the present disclosure may be Ethereum, an Ethereum Virtual Machine compatible blockchain, Tezos, Bitcoin, or any other cryptographic blockchain system.

The present disclosure describes matter, which may (in this application or a continuing application) be claimed as an invention, which is operational with numerous general purpose or special purpose computing system environments or configurations. Examples of well-known computing systems, environments, and/or configurations that may be suitable for use with the disclosed devices, systems and methods include, but are not limited to, personal computers, server computers, cloud computing, hand-held or laptop devices, multiprocessor systems, microprocessor, microcontroller or microcomputer based systems, set top boxes, programmable consumer electronics, ASIC or FPGA core, DSP core, network PCs, minicomputers, mainframe computers, distributed computing environments that include any of the above systems or devices, and the like.

The headings provided in the disclosure below are provided merely for convenience to the reader and should not be used to in any way to limit any claimed invention.

I. Device—Hardware Generally.

In various forms of the devices, systems and methods, different hardware components can be utilized, omitted, or substituted. A functional block diagram follows, describing at a high-level various hardware components or functions that may be implemented in varying combinations and arrangements different forms of the disclosure and any claimed invention. The connections between the blocks in the diagram are also illustrative of merely one form of the disclosure and the blocks may be connected in any other manner.

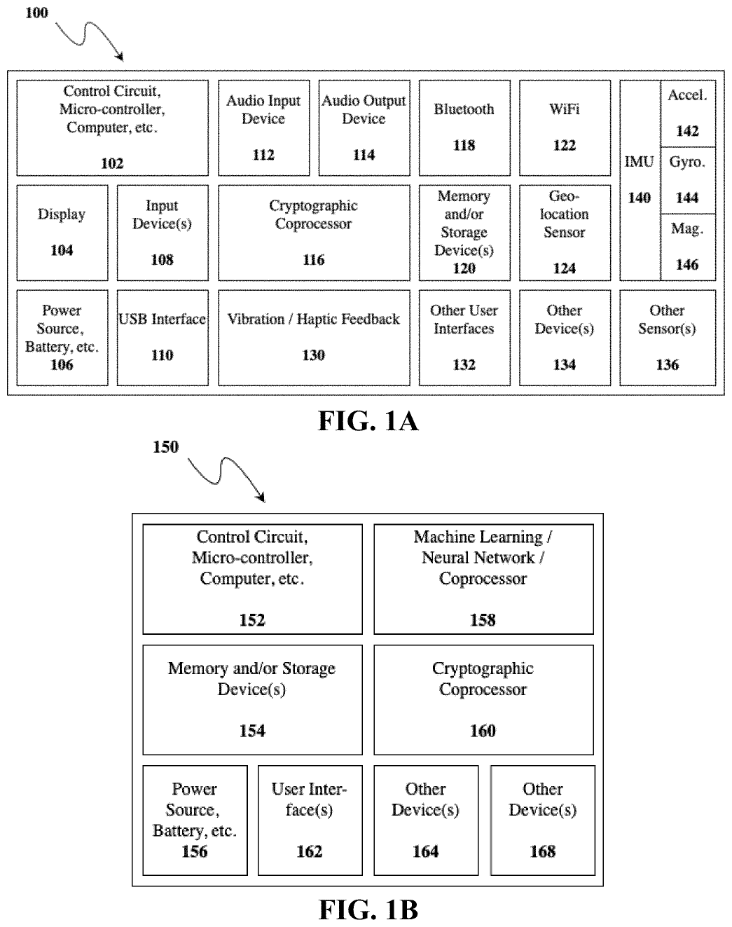

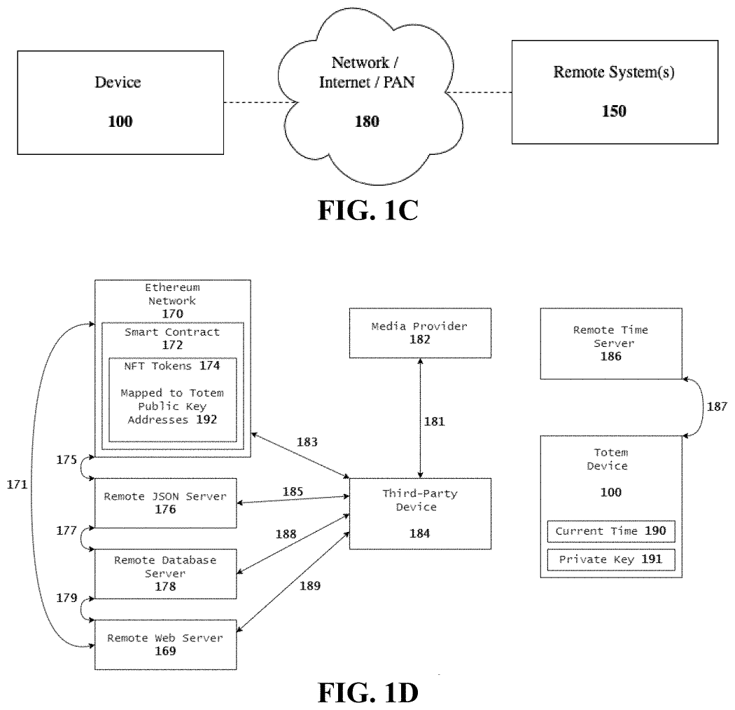

Referring to FIG. 1A, the numeral 100 generally designates a block diagram for one example form of a totem device contemplated herein.

As will be more fully described below, apparatus 100 is, in some forms, configured to store a private cryptographic key associated with a user, record corroborating information about the environment as a corroborating data set (CDS), cryptographically sign or encrypt information based on the CDS to form a cryptographic verification code (CVC), and then display or otherwise emit the CVC. Ideally, any first-party or third-party media taken of the user would capture the CVC. The CVC cannot be convincingly manipulated by computers, while the images, video, and audio portions of the media may be manipulated by traditional or “deep fake” techniques. A mismatch between the CVC and the depiction in the media indicates that the media is not trustworthy.

Referring to FIG. 1A, apparatus 100 may include any combination of the following: a control circuit 102, a display 104, power source 106, input device(s) 108, USB interface 110, an audio input device 112, an audio output device 114, a cryptographic processor 116, a Bluetooth Interface 118, Wi-Fi Interface 122, Other Communications Interface(s), Vibration or Haptic Feedback Device(s) 130, Other User Interface(s) or Feedback Devices 132, Other Device(s) 134, an Inertial Measurement Unit 140, an Accelerometer 142, Gyroscope 144, Magnetometer 146 and/or Other Sensor(s) 136.

The control circuit 102 may be any kind of circuit or combination of circuits, including: analog circuitry, digital circuitry, one or more microcontrollers, one or more field programmable gate arrays (FPGA), one or more application specific integrated circuits (ASIC), or any other type of electronic device or circuitry.

In forms of the device incorporating a display 104, a display device may be any one or combination of the following: light emitting diodes (LEDs), liquid crystal display (LCD), organic light emitting diodes (OLEDs), e-paper, or any other type of display device.

The power source 106 may be any type of power source including a wired power source (e.g., an AC adapter, etc.), a wireless power source (e.g., a wireless charger such as one that operates with the Qi standard, etc.), a standard battery or combination of batteries (e.g., Coin Cell, AA, AAA, 9V, etc.), or a rechargeable battery (e.g., 18650, LiPo, NiMH, etc.).

In forms of the device incorporating an audio input device 112, the audio input device may be any type of microphone, or other device capable of capturing sub-audible, audible or other sounds.

In forms of the device incorporating an audio output device 114 or haptic feedback device, the audio output or haptic feedback device may be any one or combination of the following: speaker, buzzer, vibration motor, or any other type of sub-audible, audible or sensory feedback device.

The device 100 may implement one or more communication interfaces such as: a USB Interface 110, Bluetooth Interface 118, Wi-Fi Interface 122, or any other communications interface. For example, the device may include an Ultra-Wideband (UWB) interface to provide precise relative positioning to other devices.

The device 100 may also implement different sensors such as an Inertial Measurement Unit (IMU) 140 (which may contain an Accelerometer 142, Gyroscope 144, Magnetometer 146), or the device may incorporate one or more individual Accelerometer 142, Gyroscope 144, Magnetometer 146 sensors apart from an IMU. Device 100 may also include any other type of device(s) 135 and/or sensor(s) 136.

For purposes of illustration and without limitation of any claimed invention, a working prototype of a form of the device has been constructed based on a special purpose development board in a watch form factor. Specifically, a TTGO T-Watch 2020 V3 with an ESP32 processor, ST7789V 1.54 Inch Display with FT6236U Capacitive Touch Screen Chip, BMA423 AxisSensor, Max98375A Speaker, PCF8563 Real Time Clock, Infrared Emitter, Vibration Motor, AXP202 Power Management Unit, Lithium battery, PDM microphone, Wi-Fi, Bluetooth, and additional components. See, e.g., Cite Nos. D0021-26, D0034, D0044, and D0075.

I.A. Totem Device Form Factor(s). Cryptographic “Totem” device(s) can take a great number of forms or designs.

(1) The device may be a physical personal device. Apparatus 100 may be configured in the form of a portable device, and more particularly many forms of the device may have the appearance of an item of clothing or a fashion accessory, and/or an object that can be placed on or near a desk or podium.

(2) The device may be a virtual personal device. Apparatus 100 may be configured in the form of a virtual portable device. For example, when using a mobile device or phone to capture video, the virtual apparatus 100 may be virtual object that is overlaid on the media that is being produced by a user using their mobile device or phone. A virtual totem device 100 (e.g., an overlay, annotation, or similar, etc.) is inserted into a user's video stream during a video chat or broadcast by the user's device will protect the user from any later modification of the transmitted media.

(3) The device may be a physical multi-user device. Apparatus 100 may be configured in the form of a physical device that is configured to work with multiple users (e.g., speakers at an in-person conference, etc.)

(4) The device may be a virtual multi-user device. Apparatus 100 may be configured in the form of a virtual device that is configured to work with multiple users (e.g., news anchors working at a news studio producing a video broadcast with no live audience).

I.A.1. Physical Personal Totem. A cryptographic totem can be a physical personal device. A totem device may take any form factor. Some examples of possible form factors are provided below.

I.A.1.i. Form Factors. For purposes of illustration and without limitation of any claimed invention, the device may be a portable or wearable device. The device may take the form of any of the following, or other, devices.

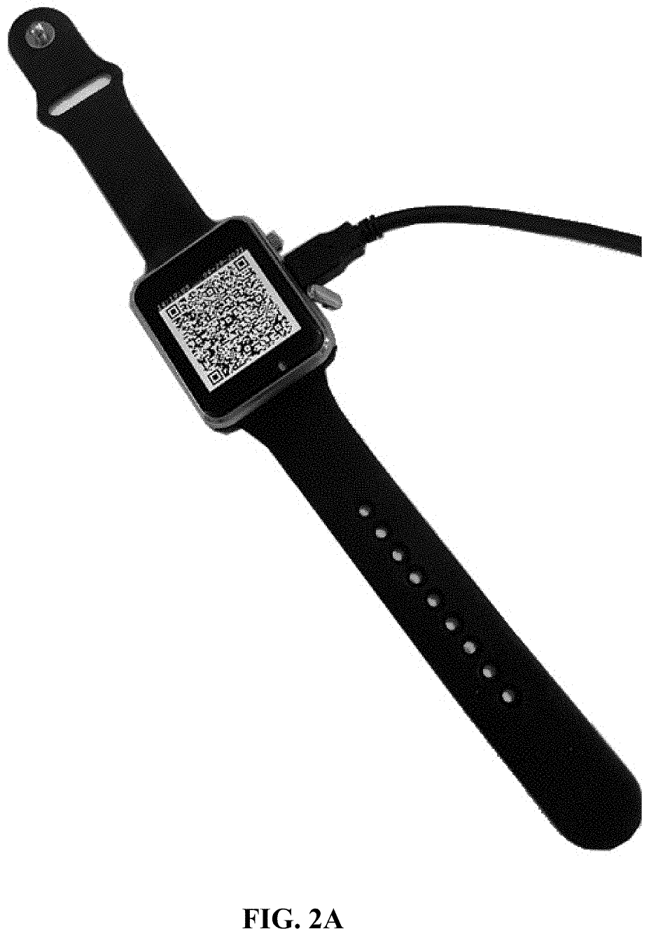

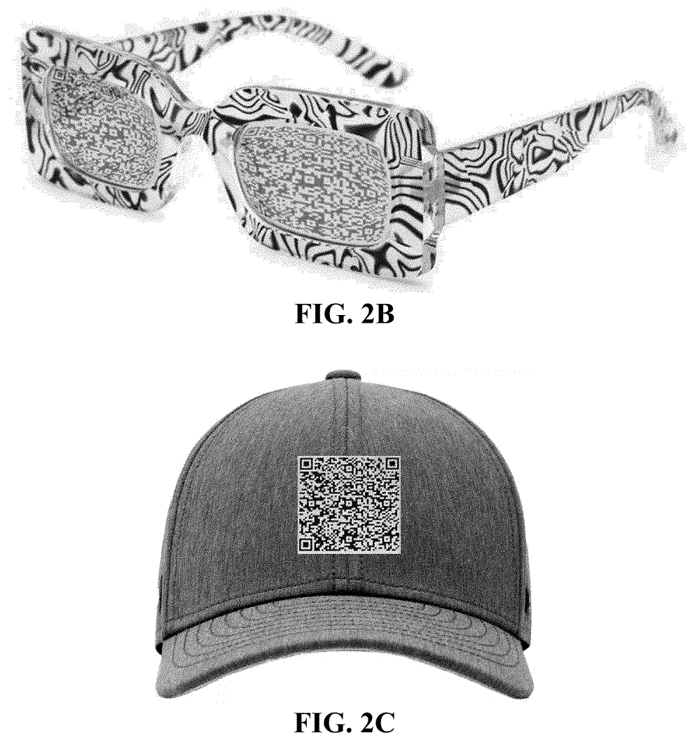

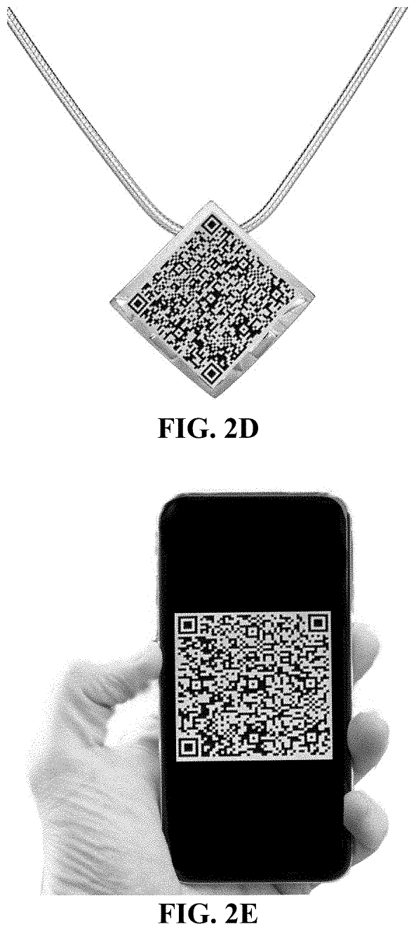

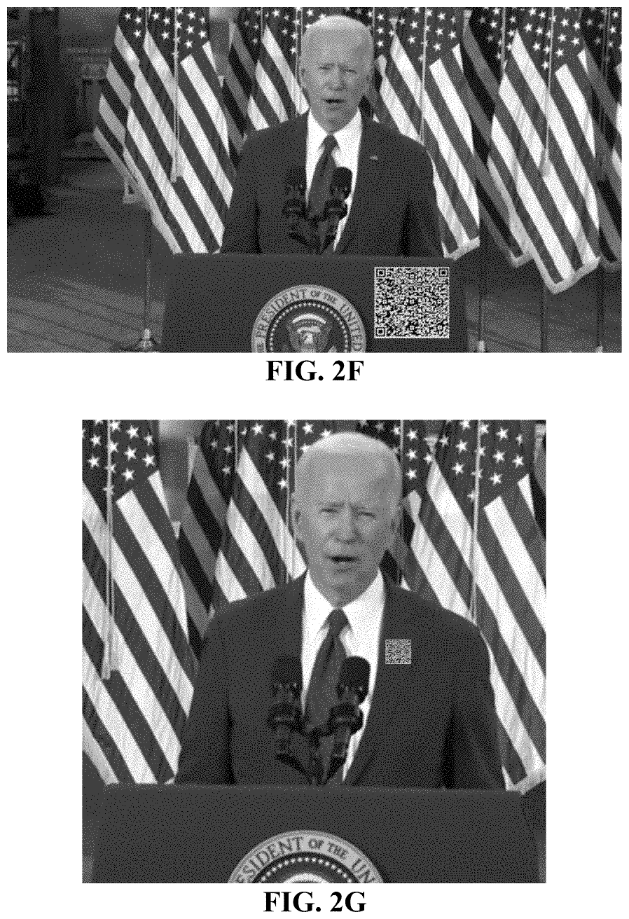

I.A.1.i.a. Watch (including but not limited to an Apple Watch, etc.) See, e.g., FIG. 2A. A watch may show the cryptographic verification code as part of its watch face or complications. Alternatively, or additionally, the watch may include a speaker to produce a sub-audible tone that encodes a cryptographic verification code.

I.A.1.i.b. Glasses. See, e.g., FIG. 2B. A pair of glasses may have a display on any surface that presents a barcode or other design that encodes cryptographic verification code information. For example, a pair of glasses with a surface including a display may generate a tortoise shell or other patterned design that simultaneously is used to encode data for the cryptographic verification code. Alternatively, or additionally, the glasses may include a speaker to produce a sub-audible tone that encodes a cryptographic verification code.

I.A.1.i.c. Hat and/or Face Mask. See, e.g., FIG. 2C. A hat may have a display on any surface that display a barcode or other design that encodes cryptographic verification code information. The hat may be configured to embed the cryptographic verification code in a coded image that resembles a logo that would typically be placed on a hat. Still further, the cryptographic verification code may Alternatively or additionally, the hat may include a speaker to produce a sub-audible tone that encodes a cryptographic verification code.

I.A.1.i.d. Jewelry (including but not limited to a necklace, bracelet, broach, cuff links, tie clip, pocket square, lapel pin, etc.). See, e.g., FIGS. 2D and 2G. An item of jewelry may have a display on any surface that display a barcode or other design that encodes cryptographic verification code information. For example, an item with a surface including a display may generate a gem or stone like patterned design that simultaneously is used to encode data for the cryptographic verification code. Alternatively, or additionally, the item may include a speaker to produce a sub-audible tone that encodes a cryptographic verification code.

I.A.1.i.e. Phone (including but not limited to an iPhone, Android Phone, etc.) See, e.g., FIG. 2E. A mobile device or phone may show the cryptographic verification code as part of its screen. Alternatively, or additionally, the phone may include a speaker to produce a sub-audible tone that encodes a cryptographic verification code.

I.A.1.i.f. Plaque. See, e.g., FIG. 2F. A plaque or other item may show the cryptographic verification code on a display. Alternatively, or additionally, the plaque may include a speaker to produce a sub-audible tone that encodes a cryptographic verification code. The plaque may be any type of item including a display that stands on a desktop like an office name plate, a larger display that is affixed to a podium, or any other form for placement near or adjacent to the owner in a setting where the private key owner may be photographed or the subject of media production activities.

I.A.1.i.g. Body Camera (e.g., Police, Firefighters, etc.). A body camera may have an external facing display for the purposes of displaying a cryptographic verification code to the general public. Alternatively, or additionally, the watch may include a speaker to produce a sub-audible tone that encodes a cryptographic verification code.

I.A.1.i.h. Or any other item that may be worn or carried with or by the user may be configured to produce and distribute a cryptographic verification code.

The devices further typically include at least a processor, sensors, and memory. The processor, sensors, and memory work together to gather and format corroborating information about the wearer of the device and environment. Then, the device uses cryptographic techniques to encrypt and/or sign the corroborating information using a private key. Then, the device communicates a cryptographic verification code into the environment that would be detected in any recording of the wearer of the device.

I.A.1.i.i. Device with Display. In forms of the device, the device may include a display. The device may record corroborating data sets using its sensors and then create a cryptographic verification code that is displayed on the display of the device. The displayed cryptographic verification code is configured and sized to be legible in photos, videos and other media of the wearer taken by a third party.

For purposes of illustration and without limitation of any claimed invention, a CEO giving an interview with a news organization wears a cryptographic Totem in the form of a broach on her outfit. The broach is a device that includes a processor, a microphone and a display. The broach uses the microphone and processor to collect real time information and create corroborating data sets based on at least the audio levels and/or audio spectrum as she speaks. The device then uses a stored private key to encrypt and/or sign the corroborating data sets to create a cryptographic verification code. The device is configured to display the cryptographic verification code on the face of the broach. The face of the broach is worn to be visible on the camera. Any later deep fake modification of the video recording will be inconsistent with the cryptographic verification code presented on the face of the broach during the interview.

I.A.1.i.j. Device with Speaker. In forms of the device, the device may include a speaker. The device may record corroborating data sets using its sensors and then transmit sub-audible cryptographic verification codes. The sub-audible cryptographic verification code is configured to be recoded in audio and video recordings taken of the wearer.

For purposes of illustration and without limitation of any claimed invention, a professor having office hours wears a cryptographic Totem in the form of a pair of glasses. The glasses are a device that includes a processor, a microphone and a speaker. The glasses use the microphone and processor to collect real time information and create corroborating data sets based on at least the audio levels and/or audio spectrum as the professor speaks. The device then uses a stored private key to encrypt and/or sign the corroborating data sets to create a cryptographic verification code. The cryptographic verification code is then broadcast with sub-audible tones using the speaker of the glasses device. Any recordings made of the professor during the office hours will have the cryptographic verification code embedded in them as well. Any later deep fake modification of the audio recording will corrupt the sub-audible encoding of the cryptographic verification code or be inconsistent with the cryptographic verification code. If the professor is later accused of saying something inappropriate during office hours as evidenced by a recording, the cryptographic verification code embedded in the recording will either prove the allegations if true or disprove the allegations if it is shown the audio was modified.

For purposes of illustration and without limitation of any claimed invention, a company CEO wearing a totem wristwatch initiates a call with the CFO of the company and demands an immediate emergency wire of a large sum of money. The CEO's phone is recording audio and video to transmit as part of the video call with the CFO. The CEO's watch is independently capturing audio information using its microphone create corroborating data sets. The device then uses a stored private key to encrypt and/or sign the corroborating data sets to create a cryptographic verification code that could only be created by the CEO. The CEO may display the cryptographic verification code on the camera during the video call, or a (sub-)audible cryptographic verification code may be transmitted to the CFO. The CFO's mobile or other device may be used to analyze the cryptographic verification code, and optionally the content of the video (using neural network or other techniques) to ensure that the other party is in fact the CEO and that the content of the video call (and in particular the request and instructions for wiring a large sum of money) is genuine. If there is a mismatch or other issue with the cryptographic verification code, the CFO can avoid sending a large sum of money to a scammer using deep fake video manipulation or other techniques.

I.A.1.i.k. Device with a Screen and Speaker. In forms of the device, the device may include both a display and a speaker. The device may record corroborating data sets using its sensors and then both transmit sub-audible cryptographic verification codes using a speaker or buzzer and display visual cryptographic verification codes on the display of the device. The displayed cryptographic verification code is configured to be legible in photos, videos and other media of the wearer. The sub-audible cryptographic verification code is configured to be recoded in audio and video recordings taken of the wearer.

For purposes of illustration and without limitation of any claimed invention, a police officer wears a cryptographic Totem in the form of a body camera. The body camera is a device that includes, among other things, a processor, a microphone, a speaker, and a display. The body camera Totem is worn on the chest of the police officer and includes an outward facing display. The device uses the and processor to collect real time information and create corroborating data sets based on at least the audio levels and/or audio spectrum as the police officer speaks and interacts with citizens. The device then uses a stored private key to encrypt and/or sign the corroborating data sets to create a cryptographic verification code. The cryptographic verification code is then both broadcast with sub-audible tones using the speaker of the device, and also displayed on the exterior display of the device. Any recordings made of the police officer by third-party citizens will have the cryptographic verification code embedded in them as well. If the police officer and body camera are on in the frame of the third-party recording, the cryptographic verification code will be visible in the video. If not, the sub-audible cryptographic verification code will also be on the audio recording made as part of a third-party video. Any later deep fake modification of the video recording by a third party will be inconsistent with the cryptographic verification code presented on the face of the bodycam in a recording. Similarly, any later deep fake modification of the audio recording will corrupt the sub-audible encoding of the cryptographic verification code or be inconsistent with the cryptographic verification code.

For further illustration, a third-party citizen wearing a cryptographic Totem that is caught on a police officer body camera will similarly be protected from deep fake or other video manipulation techniques. The corroborating data sets may be configured to include a hash or other encoding of the totem's prior data (e.g., prior corroborating data sets, prior cryptographic verification images). This creates a chain of encrypted data. Any selective editing, even if otherwise consistent, could easily be shown using the decoded cryptographic verification codes.

I.A.2. Virtual Personal Totem. A cryptographic totem may not be a physical item but may also be a video overlay or a virtual item. For example, it may be a software component of a personal mobile device or other computing device that can be used in any number of contexts where a user is broadcasting video, audio, or other content online or as part of a virtual or mixed reality world.

I.A.2.i. Video Chat or Conference (e.g., WebEx, Zoom, YouTube, FaceTime, etc.). In forms of this aspect of the disclosure, a computing device that is used for a video conference or web broadcast is configured to record corroborating data sets using its sensors and then create a cryptographic verification code that is coupled to an audio or visual recording of the user of the computing device. The cryptographic verification code is configured to be displayed with the transmitted media of the user.

For purposes of illustration and without limitation of any claimed invention, a company CEO initiates a video call with the CFO of the company and demands an immediate emergency wire of a large sum of money. The CEO's phone is recording audio and video to transmit as part of the video call with the CFO. The CEO's device also uses the audio and video information captured for the video call to create corroborating data sets. The device then uses a stored private key to encrypt and/or sign the corroborating data sets to create a cryptographic verification code that could only be created by the CEO. The device is configured to couple the cryptographic verification code to the audio and visual information transmitted to the CFO. The CFO's mobile device may analyze the cryptographic verification code, and optionally the content of the video (using neural network or other techniques) to ensure that the other party is in fact the CEO and that the content of the video call is not modified. If there is a mismatch or other issue with the cryptographic verification code, the CFO can avoid sending a large sum of money to a scammer using deep fake video manipulation techniques.

I.A.2.ii. Games/Virtual Reality (VR). Game Telemetry in the Corroborating Data. In forms this aspect of the disclosure, a computing device that is in a game playing mode (e.g., 2D, 3D, VR, etc.) is configured to record corroborating data sets using its sensors and then create a cryptographic verification code that is coupled to the game character and the audio or visual recording of the user of the computing device. The cryptographic verification code is configured to be displayed with the transmitted media of the user and/or in conjunction with the game avatar.

For purposes of illustration and without limitation of any claimed invention, a gamer is playing a video game. The gamer's computer is recording audio and video of the gamer for transmission to the other parties in the game. The device also uses this information to create corroborating data sets. The device then uses a stored private key to encrypt and/or sign the corroborating data sets to create a cryptographic verification code. The device is configured to couple the cryptographic verification code to the audio and visual information transmitted to the other game players. In addition, telemetry about the game character or game state may be further used as part of the corroborating data set that is encoded into the cryptographic verification code. Any later deep fake modification of the audio or video recording of the user or any modification to the depiction of the game state will be inconsistent with the cryptographic verification code that was coupled to the gameplay.

I.A.2.iii. Augmented Reality (AR) or Mixed in Reality (MR). Authorized Modifications in the Corroborating Data. The user can record an AR video of themselves that modifies the user's face and voice. The information about the augmented reality filter applied can be included in the corroborating data set, or the corroborating data set can be created with audio and other information that has been modified by the filter before the cryptographic verification code is created. That way, a content creator can distribute verifiable content that is modified by deep fake and other algorithms by the creator, but that prohibits further modification (consistent with the cryptographic verification code generated by the creator) by third parties.

I.A.3. Physical Multi-User Totem

When there are large events with speakers and many third parties that may record media at the event, a multi-user device with a large display present on stage may be desirable.

The device may be a multi-user device in a public setting such as an auditorium, podium, desk, etc.

In other forms the device may be a larger form factor device. The device may be placed in an exhibition hall, auditorium or other public place. The device may also be affixed to a desk (e.g., news anchor, world leader, podium, etc.)

The problem with a device like this is that the private keys of the speakers will need to be used to encode the cryptographic verification code for each speaker, but these should not be shared with anyone including the event organizer.

I.A.3.i. Enlarging a Personal Device Display. In one form of this aspect of the disclosure, the larger format displays simply show or re-broadcast a cryptographic verification code produced by a personal device associated with a speaker.

For purposes of illustration and without limitation of any claimed invention, cameras may be set up on stage to focus on and enlarge the personal devices worn by the speakers. They could be reproduced on to larger screens at the event.

In some forms of this aspect of the disclosure, the personal device may wirelessly receive some or all of corroborating data from the multi-user device and sign it with a personal device and respond to the multiuser device with a cryptographic verification code to be displayed.

I.A.3.ii. Using Personal Cryptographic Keys and a Personal Device.

Alternatively, the speaker's personal totem device may wirelessly connect to a presentation display (optionally with the authorization of the totem owner) and cast, (wirelessly) transmit, or otherwise provide cryptographic verification codes to the display or multi-user device.

In some forms of this aspect of the disclosure, the personal device may wirelessly receive some or all of corroborating data from the multi-user device and sign it with a personal device and respond to the multi-user device with a cryptographic verification code to be displayed.

I.A.3.iii. Using a One Time Use Key. Additionally, or alternatively, in these types of situations, a one-time use private key given to or generated by the user or the multi-user device for use during an event or for a specific presentation. This public key is stored in a remote key storage system as an authorized key for the event during the defined time range.

For purposes of illustration and without limitation of any claimed invention, in some forms of this aspect of the disclosure the speaker may instruct their personal totem to:
generate a new private/public key pair on the personal totem.
To scan or obtain event and time information from the multi-user device, then generate a new private/public key pair on the personal totem limited to the event and time range. The user may be presented with a dialog to confirm use of the new private key during that time.
Alternatively, the totem may obtain information the private and/or public key from the multi-user device such as a podium (e.g., automatically, by requesting it, by scanning a code displayed on the podium, etc.). The speaker may verify the code is only valid for the particular event/time range (e.g., a confirmation dialog may be presented to.
Any other method.

In any event, the temporary key, once verified, can be associated with the user's profile as an authorized key for purposes of later verification.

I.A.4. Virtual Multi-User Totem

In some forms the device is a virtual multi-user device. For example, a virtual multi-user device may be well suited for a private events or televised events where there is less likely to be third parties recording at the event may.

In forms of the device, the device may be “virtual” in that it is overlaid on top of (or embedded as metadata into) media recorded in studio or other private setting that is then meant to be distributed to the world.

I.A.4.i. Deepfake Proofing Official Announcement.

For purposes of illustration and without limitation of any claimed invention, an announcement from a world leader may include a cryptographic verification code generated and overlaid on the video. This code can then be verified any time it is played on any system. First, the cryptographic verification code may be used to confirm that the identity of the person in the video is in fact the world leader. Second, the cryptographic verification code can be used to obtain a corroborating data set. The corroborating data set is cryptographically signed or encrypted using a private key known only to the world leader. The corroborating data set contains data recorded contemporaneously with the media such that it depicts the true state of the environment at the time the media was produced. To the extent the video depiction differs from the cryptographically verifiable corroborating data set, the video can be deemed unreliable and quite possibly a “deep fake.”

I.A.4.ii. Deepfake Proofing News Broadcasts.

Similarly, for purposes of illustration and without limitation of any claimed invention, a newscast may include a virtual overlay of a cryptographic verification code. When third parties crop clip and discuss the clip-on podcasts or other third-party YouTube (or similar) channels, all viewers can use the code to verify that the news clip has not been modified or spliced by the third-party commentator to increase ratings.

For example, if the video is played on CNN or Fox News with the cryptographic verification code overlay, any third party can use an application on their mobile device (or built into a media viewer on a TV or computer, etc.) to scan the media and cryptographic verification code to independently verify the information in the video and that CNN or Fox News have not modified or selectively cut the video. The verification application can verify the cryptographic verification code and read the corroborating data set from the cryptographic verification code. Then, the mobile device application can compare the corroborating data set to an analysis of the media as it is played. Timestamps and other data can be used to determine whether or not the video segments were selectively cut. When the cryptographic verification codes and corroborating data sets are chained together with block hashes, further continuity protection may be provided.

I.A.4.ii.a. Example of Television Broadcast Application with Virtual Device. In situations where there is no live audience, such as a television news broadcast, the device may be a computer or video processing device that adds the cryptographic verification image to the broadcasted video feed.

Could be put on screen of television shows/news as an overlay to prevent later deep fake of news anchors. Cryptographic keys Could be associated with individual anchors, particular shows, or networks or companies.

I.A.4.iii. Deepfake Proofing Security Systems.

In another form of the disclosure, security or other third-party cameras may be configured to receive digital cryptographic verification codes broadcast from nearby personal devices. These third-party cameras or security systems may then overlay the received digital cryptographic verification codes on the media or merge the received cryptographic verification codes with the captured media.

For purposes of illustration and without limitation of any claimed invention, a user walks into a convenience store and the user's personal device begins communicating with the security system to provide cryptographic verification codes to the security system. The user's device may do this in one of several ways:
1. The user's personal device may use onboard sensors to collect corroborating data sets.
2. The user's personal device may be provided with data from the third-party system in real time to include in or use as the corroborating data set.
3. The user's personal device may use onboard sensors as well as being provided with data from the third-party system in near real time to include or use as the corroborating data set.

In any of the above or other cases, the user's personal device then may sign or encrypt the provided corroborating data with the private key stored on the device. Finally, the user's personal device may then transmit the signed or encrypted cryptographic verification code back to the security system for inclusion in the media.

I.A.S. Any Other Form Factor. Any other device 100 form factor may be utilized. For example, generally, any form of device 100 (whether physical or virtual), that can:
1. Gather or obtain corroborating data sets from its own sensors or trusted third party sensors,
2. Utilize a stored private encryption key of a user to produce a cryptographic verification code, and
3. Emit, display, transmit, embed, etc. the cryptographic verification code either:
   a. into the environment such that the cryptographic verification code would be captured by a third-party creating media of the user, and/or
   b. Into a media file being produced by the device or another apparatus that the device 100 is in communication with.

Still, other forms and form factors not explicitly or generally contemplated herein may be used if consistent with the purpose and scope of the methods and systems described herein.

II. User Device Method(s) for Generating Cryptographic Verification Code, Generally.

In various forms of the disclosure, different methods for configuring a user device, gathering corroborating data sets, creating cryptographic verification codes, and distributing those codes may be used.

For purposes of illustration and without limitation of any claimed invention, example methods and working examples are provided in the following sections. However, these methods and examples may be modified in many different ways to provide alternative implementations with the same, reduced or additional features and capabilities.

ILA. Device Setup.

II.A.1. Private Key Configuration and Public Key Dissemination.

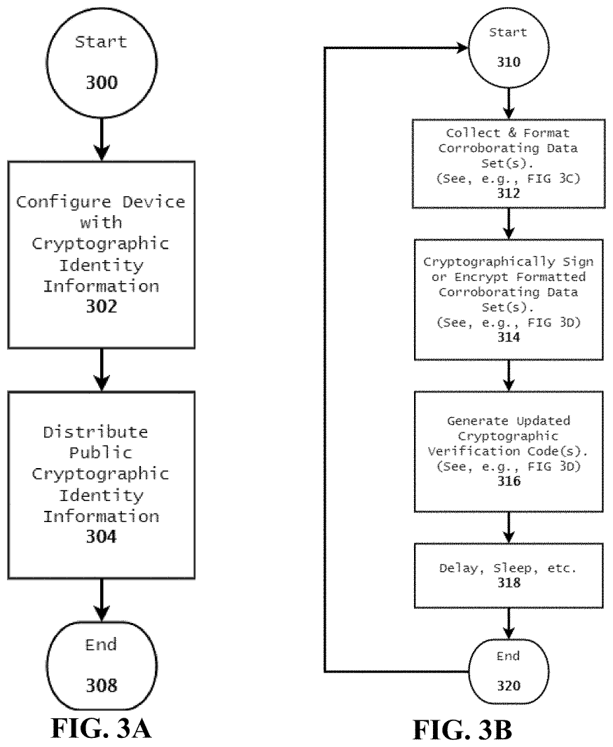

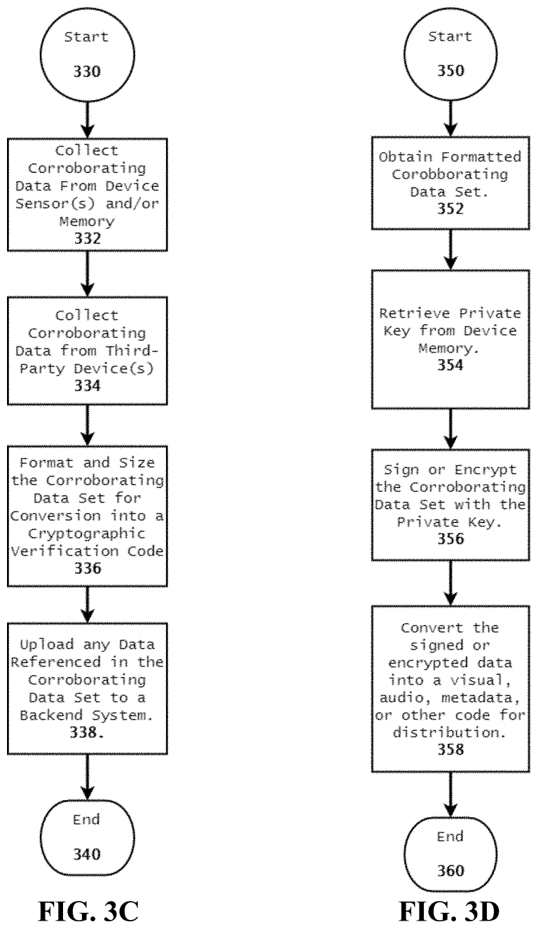

With reference to FIG. 3A, one example device setup method is depicted.

At act 300, the process starts.

At act 302, the device is configured with cryptographic identity information. The cryptographic identity information can be configured on the device. For example, the device may generate its own private and public keys or import a private key from another source. As another example, the device may be programmed to include the private key (preferably in a way that is not later accessible).

At act 304, the device may optionally distribute cryptographic identity information.

In some forms of the method, the device may provide the public key to the user for distribution to third parties.

Additionally, or alternatively, in forms of the disclosure, the device may upload the public key to a backend system. The backend system may be traditional centralized systems or decentralized systems (such as the Ethereum or other blockchain networks and distributed file systems such as the interplanetary file system (IPSF)). The backend system associates the device and the public key with the user.

In various forms of the disclosure, the backend system may distribute the public key or associate the public key with a profile associated with the user.

In other forms of the disclosure, the device may be associated with a non-fungible token (NFT) or another cryptographic construct. For example, the owner of the device may acquire an NFT from a smart contract using the public address associated with the user's private key. Then, the user may configure the totem device to use the private key and include the NFT token ID in the corroborating data set. Third parties wishing to verify the cryptographic verification codes produced by the user can extract the NFT token ID from the corroborating data set and query the associated smart contract for the ownerOf(tokenId) to obtain the public address. Using the public address, the plain text of the corroborating data set, and a cryptographic signature, the third party can verify that the cryptographic verification code is authentic and associated with the holder of the NFT/the associated private key. The smart contract may also have auxiliary functions to facilitate verification of a cryptographic verification code produced by a device.

At act 308, the process ends.

II.A.2. Maintenance of Public Key Information.

To the extent the user's private key is compromised (or device lost and replaced with a new device) a new private key can be generated and the new public key stored in the backend system.

The backend system may: (1) Retain the old public key information and note that it was decommissioned on the date and time the prior key was compromised. (2) Update the public key information with the new public key and note that it was added on the date and time the new private key was generated. (3) Update device information with new begin and end dates and times (if, for example, a new device was added or used to replace a lost device). (4) If there are multiple devices that the user maintains (e.g., multiple different form factors, backup units, etc.), they may use the same private/public key, or each device may have their own public and private key maintained in a similar way. (5) Perform any other act.

In forms of is aspect of the disclosure, the device may automatically regenerate private keys periodically to help ensure that the private key in use has not been compromised. The valid date ranges for each associated public key can be updated on remote systems and websites.

TABLE
Example remote system database table including information about the
valid user's, associated devices, public key information, and valid date range information.

| User I.D. | Device I.D. | Pub. Key. | Start Date Time | End Date Time |
|---|---|---|---|---|
| 1 | 123456 | ABC123 | Apr. 1, 2021 12:00 PM | |
| 1 | 234567 | DEF456 | Apr. 1, 2021 12:15 PM | |
| 2 | 345678 | GHI789 | Mar. 27, 2021 9:00 AM | Mar. 29, 2021 1:30 PM |
| 2 | 345678 | JKL012 | Mar. 29, 2021 1:45 PM | |

In forms of the disclosure where the device is associated with an NFT token, the NFT token can be transferred from one cryptocurrency address to another address in order to update the cryptographic key in use. An event can be emitted from a smart contract upon transfer of the token, and an analysis of the events in the blockchain over time can be used to determine the appropriate public key to associate with any cryptographic verification code based on the date contained in its corroborating data set.

II.B. Main Device Loop

Once the device is configured with cryptographic information the main activity loop may commence.

With reference to FIG. 3B, an example main activity loop is illustrated.

At act 310, the process starts.

At act 312, corroborating data set(s) are collected and formatted for further processing. For example, in one form of this aspect of the disclosure, the corroborating data set may take the form:
CDS: [DEVICE_ID/NFT_TOKEN_ID] [DATE_TIME] [DEVICE_ORIENTATION] [AMBIENT_SOUND_DATA].

At act 314, the formatted corroborating data set(s) are cryptographically signed or encrypted using the private key of the user.

At act 316, a cryptographic verification code is generated and distributed. The cryptographic verification code may be a combination of the corroborating data set and a cryptographic signature. The cryptographic verification code may further be formatted as plain text, an optical code, an audible tone, metadata, or any other format for broadcast or exchange with others. For example, in one form of this aspect of the disclosure, the corroborating data set may take the form:
CDS: [DEVICE_ID/NFT_TOKEN ID] [DATE_TIME] [DEVICE_ORIENTATION] [AMBIENT_SOUND_DATA] SIG: [CRYPTOGRAPHIC_SIGNATURE].

At act 318, the device may sleep, delay, or continue to collect information for inclusion in the next update of the corroborating data set and cryptographic verification code.

At act 320, the process ends before repeating at act 310.

At least one example for of each of these steps are discussed in further detail below.

II.B.1. Gather Corroborating Data Set(s) (CDS).

A Corroborating Data Set (CDS) is created in near real time and contains information unique to the actual real-world situation pertaining to the wearer or owner of the device.

With reference to FIG. 3C, one example method of creating a corroborating data set is illustrated.

At act 330, the process starts.

At act 332, corroborating data sets are optionally collected from the device sensor(s) and/or memory.

At act 334, corroborating data sets are optionally collected from a remote/third-party device.

At act 336, the corroborating data is formatted and sized (e.g., by offloading data to a server and referencing it by a hash in the formatted corroborating data set) for conversion into a cryptographic verification code.

At act 338, any data that is offloaded by reference is queued for upload to a backend system.

At act 340, the process ends.

II.B.1.i. Corroborating Data Information Types. The corroborating information, whether obtained from the device sensors or a remote/third-party device, can be any information. Some examples of the information types may include any selection of (or any combination of) the following:

II.B.1.i.a. Device ID, Account ID, Associated NFT Token ID, etc. A device identification, account identification, or NFT token ID. These may be used to associate the device with a public cryptographic key or address in a remote system.

II.B.1.i.b. Date and/or Time Information. The current date and/or time information may be included as a timestamp or as a time range. A single date and/or time can be included or a start and end date and/or time range may be included.

II.B.1.i.c. Device Information. Information about the device generating the corroborating data set may be included. The information may include device identification information (e.g., manufacturer, model, serial number, mac address, any other identification codes or unique attributes of the device, etc.). The information may also include device state information (e.g., signal strength, battery charge, etc.).

II.B.1.i.d. Location and/or Motion Information. Current geographic information (e.g., Lat Long, Altitude, Nearby Point of Interest, etc.). Device orientation (e.g., roll pitch yaw etc.). Environmental information (e.g., Ambient temperature).

II.B.1.i.e. Environmental Information. Nearby network information (e.g., Nearby Wi-Fi or Cell Tower information, etc.). Nearby Bluetooth information (e.g., nearby devices, etc.). Nearby user information (e.g., encoded data, hashes, public keys from nearby third parties, etc.).

II.B.1.i.f. Audio Information. Audio information (e.g., fast Fourier transform, amplitude over time, audio analyzer data, etc.; easier to collect on lower power devices; prevent audio forging, etc.). A speech to text transcript of the last few words said by the individual (e.g., to prevent someone from taking an actual video of the person using the device and using a deep fake to remaster the audio and mouth movements). Other ambient audio data may also be included.

II.B.1.i.g. Biometric Information. The data set may further include biometric information. For example, if a device with a 3D mesh camera is utilized to create the corroborating data set (e.g., an iPhone with Face ID, etc.), a 3D scan data corresponding to the user's face mesh and/or face movements over the relevant time period may be included in the corroborating data set.

II.B.1.i.h. Health Information. The data set may further include health information such as, for example, steps, heart rate, glucose level, blood oxygen level, food log, etc.

II.B.1.i.i. Game and/or Virtual Reality State/Telemetric Information. If used in conjunction with a game, the game state or telemetric data of the user's player character may be included in the data set. (e.g., position, orientation, attributes, score, etc.).

II.B.1.i.j. Augmented Reality Filter Information/User Authorized Modification Information. If the wearer/owner of the totem wishes to apply an augmented reality filter to a video that is being created (e.g., using an application like Snapchat to augment a video with a face and/or voice filter concurrently with the recording of the corroborating data set), or that will be created (e.g., the user knows that they would like to apply an augmentation filter in post-production), the information about the filter may be included in the corroborating data set as an allowed filter or user authorized modification to reality.

II.B.1.i.k. Recorded Video Frame Information. Any information pertaining to frames of video generated by the device for broadcast (e.g., FaceTime, Zoom, YouTube, etc.). For example, a hash of a frame of video, hashes of several video frames, or a hash of the hashes of a set of video frames.

II.B.1.i.l. Corroborating Data Set(s) and/or Cryptographic Verification Code(s) Chain Information. A hash or other signature of the user's previous encoded data block (e.g., a blockchain of this type of data). Even if someone is able to spoof a single data frame, this would require that they spoof and hash all prior data frames as well, which substantially increases the difficulty of forging a cryptographic verification code. (A (sequential) history of all corroborating data set(s), cryptographic verification codes, and/or hashes of corroborating data set(s) or cryptographic verification codes may be maintained and transmitted to a remote system for later use in verifying 3rd party media).

II.B.1.i.m. Reference Replacement Image, Annotation, and/or Object Model. A reference to information to show in image viewers in place of the code (e.g., to make the image look normal; if code is on a hat this could be a sports team logo to place over the cryptographic code in an image viewer).

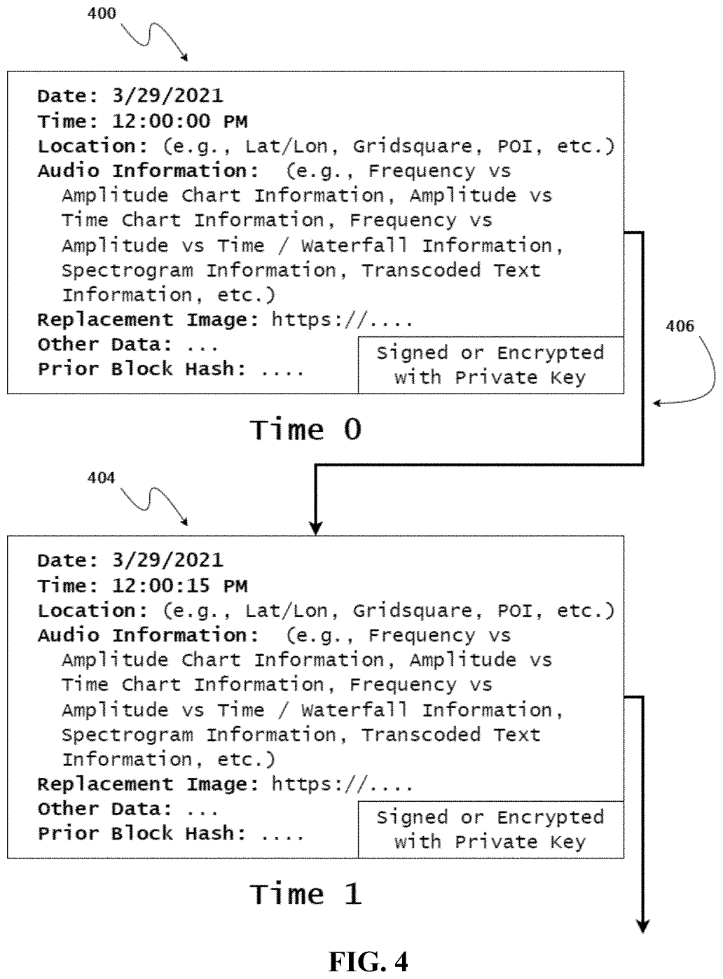

With reference to FIG. 4, one an example simplified illustration of a corroborating data set chain is depicted. A first corroborating data set 400 is depicted. Block contains data such as the date and time, location information, audio information, replacement image data, any other data, and a prior block hash. A subsequent corroborating data set 404 containing similar information but produced 15 seconds later is also depicted. The subsequent corroborating data set 404 may be linked 406 to the first corroborating data set 400 by the inclusion of the block hash of 400 in 404. This way, breaking the encryption on one data set to modify the data will break the chain of all data sets and indicate that there is an irregularity.

II.B.1.ii. Any Combination Selection or Format of Corroborating Data Types. The information types utilized for the corroborating data set(s) may pre-selected for a user or selected via a configuration screen to allow the user to customize the type of information presented in the encoded image.

II.B.1.iii. Selection of Information for Security and Other Purposes. For example, if a world leader is giving a speech, a device placed on her desk may display a coded image encoded with a private key associated with a public key known to be associated with the world leader. As she speaks, the coded image may update frequently (every fraction, 1, 5, 10, 15 seconds, etc.). The coded image may encode only information types selected for inclusion by an administrator: (a) The current date and time. (b) A point of interest (e.g., “The White House”) or obfuscated GPS coordinate (for security) near the location where the speech is being given. This information may also be explicitly left out due to security concerns. (c) Ambient audio information or a speech to text transcription of the words spoken by the world leader since the last update of the CVC. (d) A hash or other encoding of the information contained in the last CVC time block. (e) Other world leaders and the general public may take the known public key for the world leader and decode the information from the coded image to help verify the video has not been tampered with via deep fake algorithms. (f) Other information.

II.B.1.iv. Size Reduction by Reference to Corroborating Data Set, or Corroborating Data Set Items, Instead of Including the Data Set Itself.

When formatting the corroborating data set into a cryptographic verification code, information may be referenced with respect to a backend or remote system.

The corroborating data set may explicitly include information or link to another information source with a URL or a unique hash associated with the information.

For purposes of illustration and without limitation of any claimed invention, the device may collect a large amount of corroborating data with each time block. To ensure that the cryptographic verification code, when converted to a visual code, a (sub-)audible code, or any other type of code, is legible in third party photos, videos and other media (possibly from a distance), the bits encoded in the cryptographic verification code may need to be minimized.

Instead of storing all the data from the large corroborating data set(s) in the cryptographic verification code itself, the corroborating data set (which may be encrypted with the private key of the user) is hashed to obtain a fingerprint. The cryptographic verification code can encode the hash or reference to the more detailed data in the image or sub-audible tone.

The entire corroborating data set may be offloaded to a remote or backend system, or individual data types from the corroborating data set that may be too large to communicate in the cryptographic verification code may be offloaded to a remote or backend system (e.g., a time series of 3D face mesh data, etc.).

An example offloaded CDS may have the following format:
Date/Time: 3/31/2021 at 9:52 AM
Hash: QmT9qk3CRYbFDWpjDFYeAv8T8H1gnongwKhh5J68NLkLir6
   The Hash may be used in conjunction with another system to retrieve the CDS.

An example partially offloaded CDS may have the following format:
Date/Time: 3/31/2021 at 9:52 AM
AudioLevels: 1.1,1.3,3.4,4.5,5.6,5.4,6.7,7.9,4.3,3.2, . . .
FaceMeshDataHash: BqY4qk3CRYbFDWpjDFQeAv8T8H1elmogwKhh5J68NLkOpiy
   The FashMeshDataHash may be used in conjunction with another system to retrieve the partially offloaded face mesh data from the CDS.

The encrypted data can be stored and/or uploaded to a remote or backed system (e.g., a web server, the Inter Planetary File System (IPFS), etc.) contemporaneously or at a later time by the Totem device (or a device paired with the Totem such as a mobile phone, computer, etc.).

The backend system may be traditional centralized systems or decentralized systems (such as the Ethereum or other blockchain networks and distributed file systems such as the interplanetary file system (IPSF)).

During verification of the cryptographic verification code(s), the verifying device can decode the cryptographic verification code, verify the signature, and then retrieve the more detailed corroborating data set(s) from the included reference, URL, or hash. Then, further analysis comparing the media against the corroborating data set can be conducted.

### ILLUSTRATIVE EXAMPLE

In one form of this aspect of the disclosure produced as a working prototype, a CDS may be formatted as follows:
“CDS: 1 04-17-2021 16:16:18 -756 94 -735 100000110000000000000000”

The above example CDS format is as follows:

| | |
|---|---|
| 1 | An NFT tokenID number associated with |
| | this user/device in the Ethereum smart |
| | contract backend |
| Apr. 17, 2021 | The Date the corroborating data set was |
| | produced |
| 16:16:18 | The time the corroborating data set was |
| | produced |
| −756 | The X component of acceleration in the |
| | axes of the watch/accelerometer chip |
| 94 | The Y component of acceleration in the |
| | axes of the watch/accelerometer chip |
| −735 | The Z component of acceleration in the |
| | axes of the watch/accelerometer chip |
| 100000110000000000000000 | The audio spectrum intensity. Output |
| | number position from left to right. The |
| | higher number the higher the detected |
| | sound amplitude. |
| | 01)~300-500 Hz |
| | 02)~700 Hz |
| | 03)~900 Hz |
| | 04)~1100 Hz |
| | 05)~1300 Hz |
| | 06)~1500 Hz |
| | 07)~1600 Hz |
| | 08)~2000 Hz |
| | 09)~2200 Hz |
| | 10)~2400 Hz |
| | 11)~2600 Hz |
| | 12)~2800 Hz |
| | 13)~3000 Hz |
| | 14)~3200 Hz |
| | 15)~3400 Hz |
| | 16)~3600 Hz |
| | 17)~3900 Hz |
| | 18)~4000 Hz |
| | 19)~4200 Hz |
| | 20)~4500 Hz |
| | 21)~4700 Hz |
| | 22)~4900 Hz |
| | 23)~5200 Hz |
| | 24)~5500 Hz |

Here, in this instance, an amplitude of “1” was detected for 300-500 Hz, 1600 Hz and 2000 Hz. These audio frequency levels from the CVC/CDS should correspond to the relative audio levels of the media audio track from which an image of this CVC/CDS is found and extracted.

II.B.2. Create Cryptographic verification Code(s) (CVC)

Cryptographically Sign or Encode the Corroborating Information with the Private Key.

The corroborating data set information is formatted, if necessary, into a format ready to be converted to a cryptographic verification code.

Once in a format ready for conversion, the corroborating data set encrypted or signed with the private key stored in the device.

Then, the encrypted or signed corroborating data set is turned into a cryptographic verification code.

The device takes a user's private key (this can be a Bitcoin or Ethereum wallet private key, or any other type of private key or unique passcode) and uses the private key to encode the collected Corroborating Data Set(s).

With reference to FIG. 3D, an example cryptographic verification code creation and distribution method is illustrated.

At act 350, the process starts.

At act 352, a corroborating data set is obtained from memory, or a prior operation carried out on the device or remote system.

At act 354, the user's private key is retrieved from device memory or a secure enclave or other module of the device.

At act 356, the corroborating data set is cryptographically encrypted or signed with the private key. For example, this may occur using the KECCAK256 and/or SCEP256K1, or similar, algorithm(s).

At act 358, if the corroborating data set is encrypted, an unencrypted reference to the public key associated with the user may be placed in the final cryptographic verification code data. If the corroborating data set is unencrypted but signed, the signature is added to the corroborating data set (which many include a reference to the public key associated with the user). Then, the cryptographic verification code is converted into a visual, audio, metadata or other code or representation for distribution.

At act 360, the process ends.

The code may be a visual code, an audio code, any other type of code, and/or any combination of code types.

For example, the totem device 100 first produces a CDS message using its onboard clock, and other sensors. A CDS message may be as follows:
CDS: 1 04-17-2021 16:16:18 -756 94 -735 100000110000000000000000″.

In one form of this aspect of the disclosure, the CDS may be signed with a private key to create a signature such as:
0x51cfc228f28786034396bd384ebcaaa3f41daf7c34b33ce767572ef26bee1ad65dd5996c5 d0688f5148a776fc819bb27a5b10f30094da3fd69e30df5e740b3761b

This signature may be combined with the corroborating data set to produce a cryptographic verification code (CVC):
CDS: 1 04-17-2021 16:16:18 -756 94 -735 100000110000000000000000 SIG: 0x51cfc228f28786034396bd384ebcaaa3f41daf7c34b33ce767572ef26bee1ad65dd5996c5 d0688f5148a776fc819bb27a5b10f30094da3fd69e30df5e740b3761b

The signed information can then be converted into a format for distribution via audio, image or other medium. If the CVC is to be displayed, it may be converted into a coded image such as a QR code.

II.B.3. Distribute Cryptographic Verification Code(s).

II.B.3.i. Visual Code.

The encoded information may be displayed in any way (or different ways) depending on the form factor of the device. Some ways in which the code might be displayed are: (a) Barcode, (b) QR code, (c) Alphanumeric (or other text, number or symbol) encoding, (d) Zebra stripes, Tortoise Shell, Fingerprint (or other generative art pattern capable of encoding information), (e) Particle Cloud Code (e.g., Apple Watch Pairing, etc.) (See, e.g., Cite Nos. A0001 and A0002), (f) Glasses tortoise shell design pattern encoding information (or other generated patterns that can encode information; polka dots, etc.), (g) QR code embedded within an image, (h) QR code alternatives, (i) Generative artwork based on a hash, transaction id, cryptographic signature, etc., or (j) Any Other Visual Code.

The encoded information is displayed on the display or a surface of the device (if a visual cryptographic verification code is created) or broadcast with audio (if an audio cryptographic verification code is created), or both (if both are created).

The cryptographic verification codes may be distributed: (a) at all times (b) intermittently (e.g., momentarily every prior of time interspersed with the regular display or an off display), or (c) when a triggering event is detected (a nearby device taking a photo or video broadcasting a beacon signal to other devices to display their relevant codes momentarily or continuously).

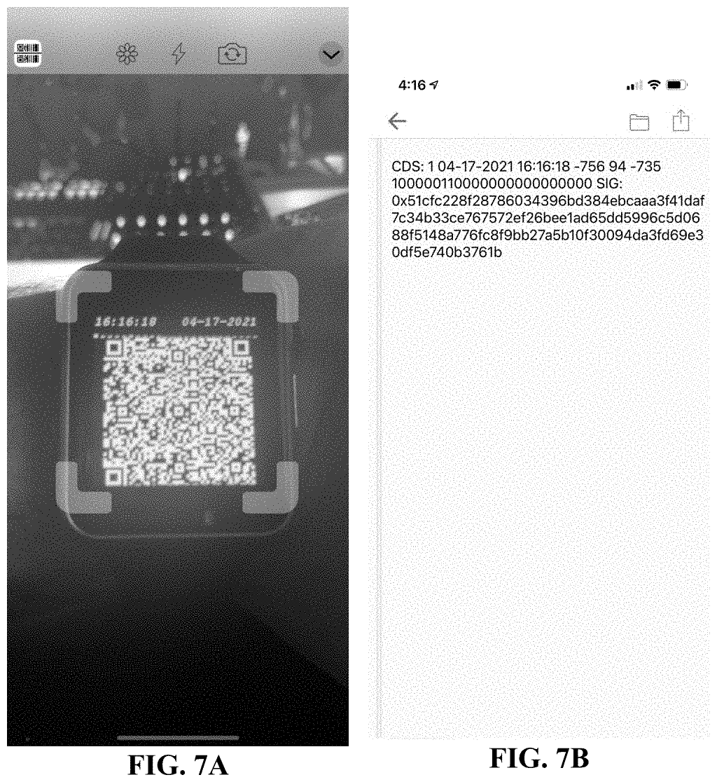

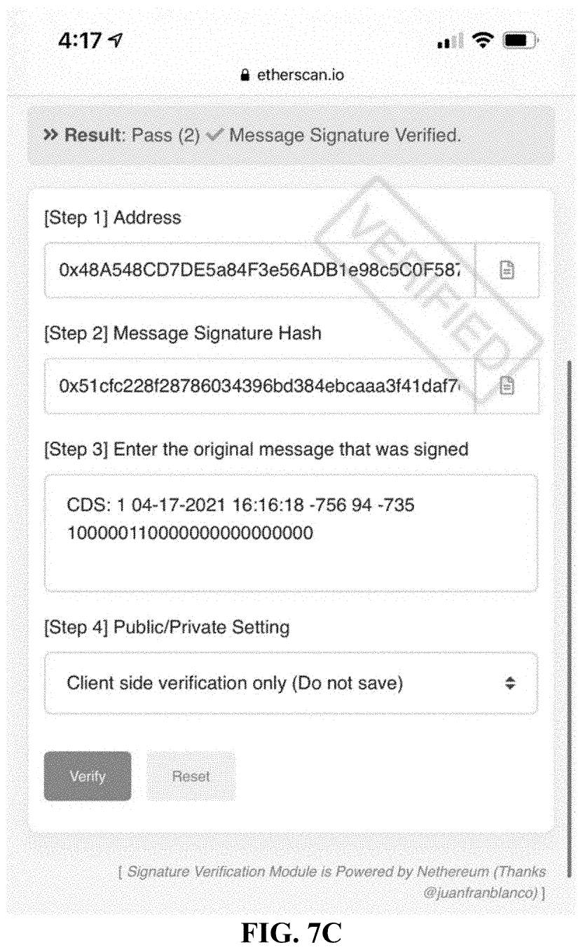

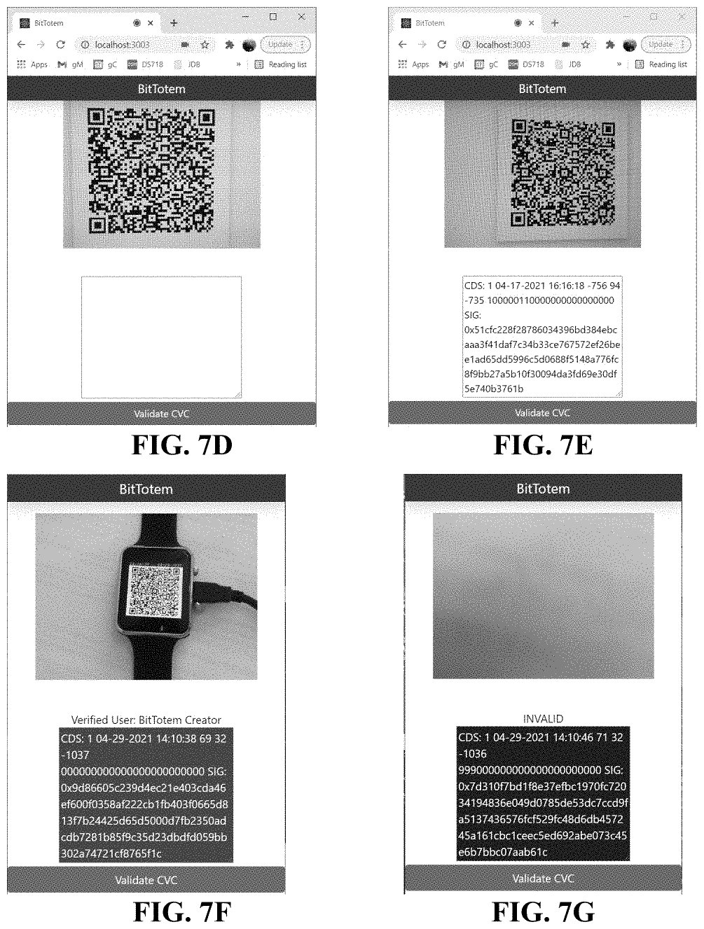

For example, with reference to FIG. 7A, in one form of this aspect of the disclosure the CVC is converted into a QR code for distribution via display on the face of a watch device.

II.B.3.ii. (Sub-)Audio Code.

The encoded information may also or alternatively be encoded as an audible or sub-audible sound for broadcast via speaker.

To verify audio recordings, an audio cryptographic verification code may be used.

The cryptographic verification codes may also, or alternatively be high frequency audio data that cannot easily be heard by human ears but will be captured by third party recording devices.

The encrypted corroborating information is broadcast via audio/sound from the device. Any third-party recording devices may capture this encrypted audio encoding cryptographic verification code on the recording. In the same or a similar manner to the visual cryptographic verification code, the audio cryptographic verification code can be decoded to: (1) verify the signature/encryption as being an authentic code, and (2) verify the corroborating data regarding the audio spectrum information around the device at the time the code was generated against the depiction in an audio recording.

In the case of an audio cryptographic verification code, the device may play the encoded data instead of or in addition to displaying a visual Cryptographic Verification Code.

II.B.3.iii. Metadata Code.

In any form of this disclosure, in addition or instead of overlaying a cryptographic verification code on the video and/or audio data, the cryptographic verification code may be inserted as metadata into the media that is being produced by the device.

For example, when streaming a video to any service (e.g., Zoom, FaceTime, YouTube, etc.), corroborating data sets may be gathered contemporaneously with the creation of the content, and then the data set may be incorporated into a cryptographic verification code that is inserted into the metadata of the video.

II.B.3.iv. Other Code.

Any other type of encoding beyond visual or (sub-)audible encodings may be used to broadcast or otherwise distribute the CVC information.

II.B.3.v. Combination of Codes.

A combination of encoding types may be used in conjunction with one another. For example, a device may display a visual CVC and emit a sub-audible CVC also. That way, third parties that are recording may both record the visual CVC when the wearer is in frame of the recording party's camera and obtain the audio CVC at all times when the recording party is within audible range of the wearer of the device.

II.B.4. Update the Data Set(s) (CDSs) & Code(s) (CVCs).

II.B.4.i. Generate and Continuously Update the Cryptographic Verification Image. The CDS/CVC may be updated in real time or in relatively quick intervals so that it is constantly refreshed and cannot be reused during a period of time sufficient for exploitation by a malicious third party.

II.B.4.ii. Repeat the Process. The above process is repeated over and over to update the corroborating information and update the Cryptographic Verification Code.

II.B.4.iii. Device Operating Modes. In various forms of the device, the device may have several operating modes. The operating modes may allow for different types of information to be included in the corroborating information and may allow for different frequency of updates. This allows a flexible configuration depending on battery life, privacy, and other concerns. The operating modes may automatically switch based on sensor or other input data such as motion, ambient sound or other information.

For example, if the motion of the device is relatively small and/or there is no ambient noise, the device may update less frequently to conserve battery. As another example, if the motion detects that the user is walking/talking/giving a red-carpet interview/etc. the update frequency may be very high, and the corroborating information may include audio as to prevent any modification of the interview with deep fake video modification techniques.

The device mode may be selected based on an input device, automatically with conventional programming techniques, or automatically with a neural network or other machine learning algorithms analyzing available inputs.

II.B.4.iv. Example of an Active Celebrity with Third Party Attention.

A celebrity wears a device while traveling. While walking through the airport, the device may detect that the user is walking based on the motion and a motion classifier algorithm. The device may also detect that there is ambient sound but that the wearer is not talking using an audio classifier algorithm. This information may be fed into another algorithm to determine the update frequency or the cryptographic verification image. In this instance the image may update at a relatively fast frequency.

The wearer may stop in the airport to take a picture with a fan or paparazzi and give a short interview. The motion classifier may determine the wearer has stopped walking. The audio classifier may detect that there are people talking nearby (either the wearer or a third party nearby). The update frequency may be even faster than when just walking to ensure that all of the corroborating audio information is encoded in the cryptographic verification images to help prevent deep fake modification later.

Sitting in a seat in the car or an airplane the device may determine that the user is stationary, and that the audio information does not indicate nearby speaking and may adjust to update the cryptographic verification images less frequently.

II.C. Other Device Functions.

In some forms of the disclosure, the totem device may display/emit cryptocurrency wallet public key or address. This may be done for purposes of message verification, or for purposes of giving a public wallet address to a third party for payment.

For example, on a wearable device, a button can be pressed to temporarily display or emit a public key, public key fingerprint, or other identifier associated with a payment account address or cryptocurrency address.

In addition, the totem device may incorporate any other type of function.

Computer code for an example website that is used to create a corroborating data set using speech to text is provided in the Code Appendix as Code Listing 1.

Computer code for example firmware to generate a corroborating data set (CDS) and display a cryptographic verification code (CVC) in real-time on a TTGO Watch 2020 V3 is provided in the Code Appendix as Code Listings 2-7.

III. Interface with a Backend System.

A backend system can be used to store public keys, user profiles, and corroborating data set and/or cryptographic verification code block histories.

History of Information.

In some forms of the disclosure, the device maintains a record of each CVI and/or Corroborating Data. This information can be stored on the device, offloaded to a personal computer or storage, or uploaded to remote systems for storage.

Remote systems may utilize the offloaded cryptographic verification images and corroborating data to assist with verification of other media from other users or of the offloading user at a later time.

Traditional Backend.

In some forms of the disclosure, a traditional backend may be utilized with the totem device. For example, traditional servers, databases, and other systems may be used as a backend (e.g., services offered by AWS, Azure, and Google Cloud, etc.)

With reference to FIG. 1C, one form of an example traditional backend system architecture is illustrated. Device 100 may connect to a Network, the Internet, or a Personal Area Network (PAN) 180. Remote system 150 may also connect to a Network, the Internet, or a Personal Area Network. Other devices may connect with the remote system 150 to retrieve stored information about a user or account via the Network/Internet/PAN 180. Other devices may, in some forms of the disclosure, also connect to the totem device 100 via the Network/Internet/PAN 180.

Blockchain Backend.

In some forms of the disclosure, blockchain backends may be utilized with the totem device. For example, decentralized systems may be used for backend data logic and storage (e.g., Ethereum, InterPlanetary File System, etc.).

One form of an example Ethereum smart contract backend is provided herein.

By storing a reference in the CDS/CVC to an NFT tokenID associated in a smart contract with the Ethereum address of a private key used to sign the message (instead of storing the public key/address in the CDS/CVC), it makes it harder for someone to forge a cryptographic verification code that they try to pass off as being real. They cannot generate a fake address to then use to generate new CVC images for insertion into video or other media, because there needs to be a genuine address stored in the smart contract associated with the NFT.

With reference to FIG. 1D, one form of an example decentralized system architecture is illustrated.

Totem device 100 may connect with a remote time server 186 via wireless connection 187. Totem device 100 synchronizes and then maintains the current time 190. Totem device 100 is configured to securely store private key 191, and optionally a reference to an NFT token ID number. Totem device 100 then creates corroborating data sets and cryptographic verification codes.

To the extent the holder or wearer of the totem is captured in media, and the media is provided to a third-party device 184 via media provider 182 and Internet connection 181, the third party may use the decentralized backend system to assist in confirming the authenticity of the cryptographic verification code extracted from the media item.

Third-party device 184 may extract the cryptographic verification code from the media and analyze the corroborating data set to determine an NFT TokenID contained within the media. Then, the third-party device 184 can query the Smart Contract 172 containing NFT Tokens 174 on the Ethereum Network 170 via Web3 connection 183 to determine the authenticity of the cryptographic verification code.

The NFT Tokens 174 may reference a Remote JSON Server 176 containing additional NFT Metadata. The Remote JSON Server 176 may update the metadata via connection 175 and may store information in Remote Database Server 178 (which may be on the same or a different server as the JSON Server). The third-party device 184 may access the Remote JSON Server 176 via connection 185 and the remote database server 178 via connection 188.

Remote web server 169 (which may be the same or different system than the others discussed above) may provide a web interface to the decentralized backend. The remote web server 169 may connect to the Ethereum network via connection 171 or the remote database server 178 via connection 179. The remote webserver may also connect to the remote JSON server 176 via a RESTFUL or other API. Third-party device 184 may connect to the remote web server 169 via connection 189.

III.A. Sales of Device via Smart Contract NFT.

The device itself may be licensed or sold (optionally along with the sale of a non-fungible token (NFT)) from a smart contract. With the purchase of an NFT, an end-user license agreement (EULA) is provided which allows access to use of the system and provision of one totem device.

Then, the totem device information can be associated with or include includes the NFT tokenId number. The owner of the NFT is the public address of the person associated with the totem device, and the totem device is configured to use the private key associated with that address to cryptographically sign corroborating data sets.

For purposes of illustration and without limitation of any claimed invention, the example Ethereum smart contract backend code provided in the associated computer code appendix implements this aspect of the disclosure in the following code segment:

```
function anyoneCreateDevice( ) external payable {
  require(msg.value >= deviceLicenseFee, “msg.value must be
>= deviceLicenseFee.”);
  require(currentTokenId < maxTotalSupply, “No more devices
are available to mint.”);
  currentTokenId++;
  uint256 _newdeviceId = currentTokenId;
  _mint(msg.sender, _newdeviceId);
  devices.push(Device(““));
  emit DeviceCreated(msg.sender, currentTokenId,
msg.value);
}
```

Value (msg.value) must be paid into the ‘anyoneCreateDevice’ function in the amount of at least ‘deviceLicenseFee’ in order to issue an NFT tokenId to the public Ethereum address associated with the function caller (msg.sender).

Computer code for example Ethereum smart contract backend is provided in the Code Appendix as Code Listings 8-10.

IV. Verifying Media.

Once media is captured or generated of a person who is displaying a physical or virtual totem device, that media may be distributed to the public. Once in the hands of the public, the media may, however, be modified by third parties. The third parties may be able to use advanced falsification techniques to change the media (e.g., “deep fake” manipulation of image, video, audio, or other data.). However, these techniques will not be able to modify the cryptographic verification code that was captured or inserted during the media creation process. The information encoded in the cryptographic verification code may be compared against the depiction of the video to facilitate determining whether the media has been modified from its original form.

For purposes of illustration and without limitation of any claimed invention, a general overview of one form of the verification process aspect of the disclosure is provided below.

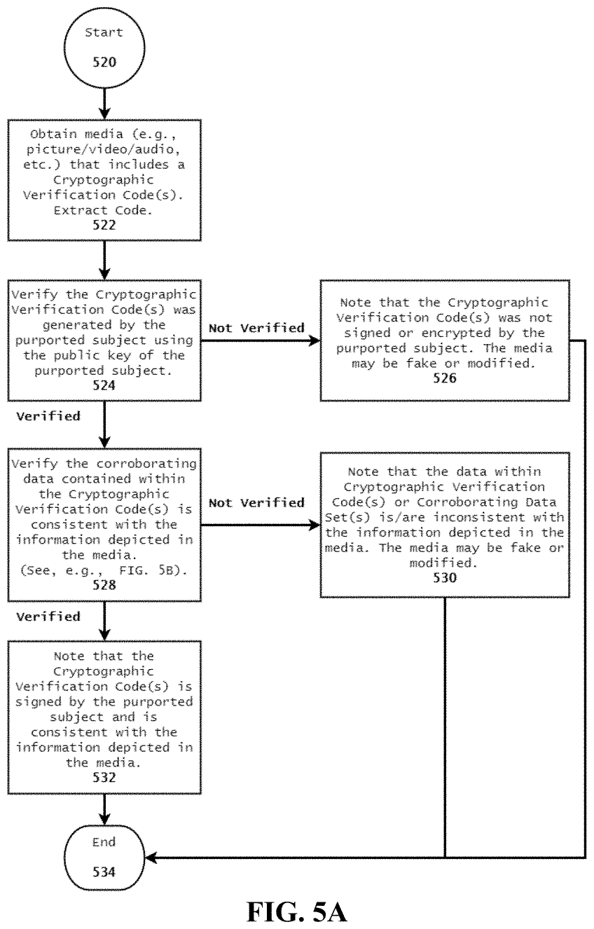

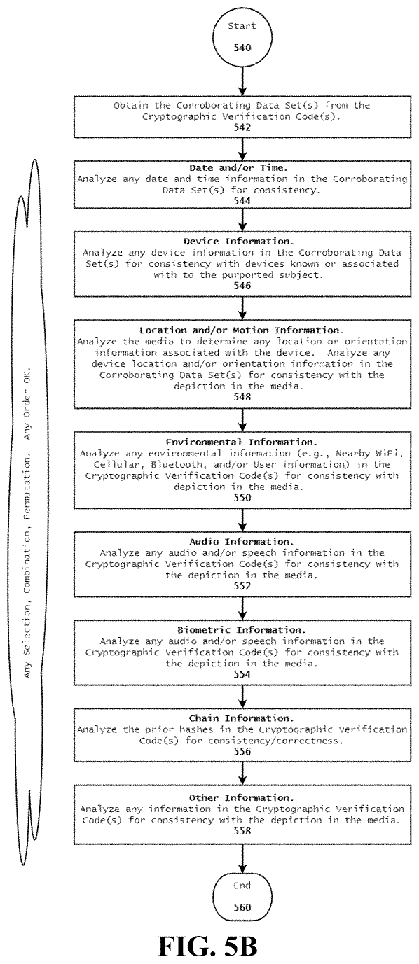

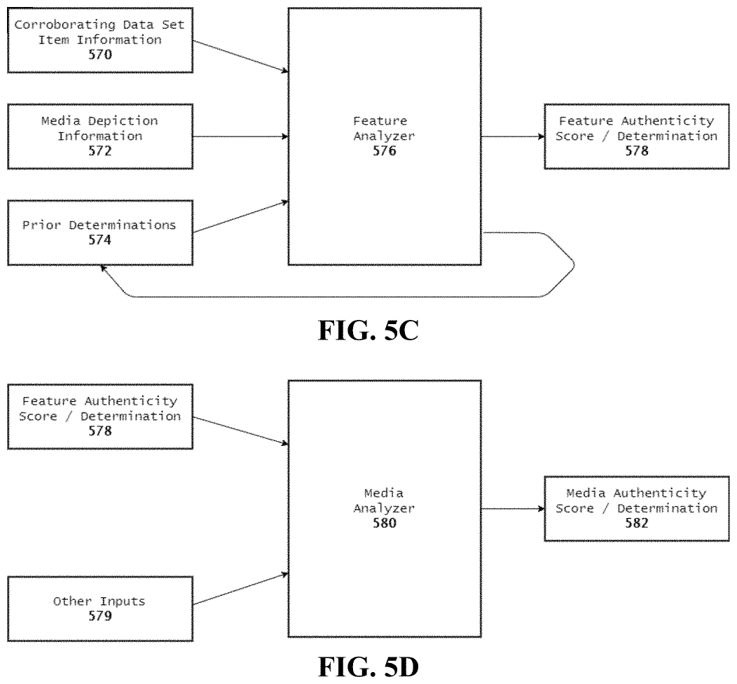

With reference to FIG. 5A, an overview of an example verification of media using a cryptographic verification code is depicted.

At act 520, the process starts.

At act 522, an item of media that includes a cryptographic verification code is loaded into the process and the cryptographic verification code is extracted.

At act 524, the cryptographic verification code is decrypted, or its signature is cryptographically verified using any combination or selection of the message plain text, the message hash, the public key of the purported subject, and/or any other information. If the cryptographic verification code is verified the process continues to act 528. If the cryptographic verification code is not verified, the process may proceed to act 526.

Decoding/Verification of Cryptographic Image.

Third parties wishing to verify the media (photograph/Live Photo/video, etc.) can decode the information from the captured (e.g., photographed image or video, recorded audio, etc.) codes using the public key (e.g., Bitcoin/Ethereum wallet address, etc.) of the purported subject of the photo or video. Alternatively, or additionally, third parties may check the signature against the public key of the purported subject.

If the coded image can be decoded or signature verified with the public key of the purported subject (and the private key has not been compromised), then the picture or video can be determined to be more credible than in the absence of the encoded image.

The additional encoded data can then be compared to other information in the picture to determine if the metadata further corroborates the accuracy of the depiction of the person in the photo or video.

At act 526, an exception is noted that the cryptographic verification code was not signed or encrypted by the purported subject (e.g., the media may be fake or modified, etc.). The process continues to act 534, where the process ends.

At act 528, the corroborating data set contained within the cryptographic verification code is analyzed to determine if it is consistent with the information depicted or conveyed in the media item. Any comparison process can be used including traditional algorithms, artificial intelligence algorithms (e.g., neural networks, deep learning, a process consistent with FIG. 5B, etc.) If the corroborating data set is verified as consistent with the media item, the process may continue to act 532. If the corroborating data set is not verified, the process may proceed to act 530.

At act 530, an exception is noted that the corroborating data set is not consistent with the media item (e.g., the media may be fake or modified, etc.). The process continues to act 534, where the process ends.

At act 532, a result is noted that the cryptographic verification code is signed by the purported subject and is consistent with the information depicted in the media. The process may continue to act 534.

At act 534, the process ends.

With reference to FIG. 5B, an overview of an example process of comparing the data contained within a corroborating data set to an item of media is depicted.

At act 540, the process starts.

At act 542, the corroborating data set(s) is(are) extracted from a verified cryptographic verification code. Then, once the corroborating data set(s) is(are) available for analysis, in any selection, combination, permutation items from the corroborating data set(s) are compared against the media item for consistency. For purposes of illustration and without limitation of any claimed invention:

At act 544, date and/or time may be analyzed for continuity and/or consistency with the media item. For example, if the time is not sequential, continuous, at the same speed, or otherwise contemporaneous with the purported truth of the media item, the discrepancy may be noted and/or factored into a final output as to whether the media item is reliable.

At act 546, device information may be analyzed for consistency with prior devices or devices registered to the purported subject. If the device is not known or associated with the purported subject, the discrepancy may be noted and/or factored into a final output as to whether the media item is reliable.

At act 548, location and/or motion and/or orientation information may be analyzed for consistency with the location and depiction of the device in the media item, information contained in a remote system and/or any other data source.

For example, if the location indicates that the totem was located a particular location but an analysis of the media shows features that are not consistent with the location (e.g., the user is near a landmark, but no visual cues of the landmark are detected; the date time and location is cross referenced with the historical weather data, but the weather depicted does not match, etc.), the discrepancy may be noted and/or factored into a final output as to whether the media item is reliable.

For example, if the motion indicates that a user is stationary, but an analysis of the media shows the user moving, the discrepancy may be noted and/or factored into a final output as to whether the media item is reliable.

For example, if the orientation indicates that the device is oriented in a particular roll, pitch and yaw orientation, but an analysis of the media shows that the device is oriented differently, the discrepancy may be noted and/or factored into a final output as to whether the media item is reliable.

At act 550, environmental information may be analyzed for consistency with information contained in the media item, information contained in a remote system and/or any other data source.

For example, if the CVC/CDS contains information about nearby Wi-Fi, Bluetooth, or other radio sources at the time the CVC/CDS was created but the media, remote server, or other information source does not contains contrary information about those radio sources, the discrepancy may be noted and/or factored into a final output as to whether the media item is reliable.

At act 552, audio information may be analyzed for consistency with the media item, information contained in a remote system and/or any other data source.

For example, if an audio magnitude level is present in the CVC/CDS but the media item's audio magnitude level is not consistent with the CVC/CDS, the discrepancy may be noted and/or factored into a final output as to whether the media item is reliable.

For example, if audio spectrum level information is present in the CVC/CDS (e.g., an FFT output that shows the magnitude of different frequency ranges from—for example—300 Hz to 6000 Hz—or any other range, etc.) but the media item's audio spectrum magnitude level is not consistent with the CVC/CDS (e.g., accounting for time delay or slippage between the CVC/CDS and the actual sounds, etc.), the discrepancy may be noted and/or factored into a final output as to whether the media item is reliable.

For example, if speech to text information is in the CVC/CDS (e.g., the device transcodes the spoken words into a text representation that is placed in the CVC/CDS, etc.) but the media item's transcript is not consistent with the CVC/CDS, the discrepancy may be noted and/or factored into a final output as to whether the media item is reliable.

At act 554, biometric data may be analyzed for consistency with the media item, information contained in a remote system and/or any other data source.

For example, if three-dimensional face scan biometric information (or a reference to said information) is present in the CVC/CDS, but a media analysis reveals that the recorded or referenced biometric data does not appear to be consistent with the media, the discrepancy may be noted and/or factored into a final output as to whether the media item is reliable.

At act 556, CVC/CDS chain information may analyzed for consistency with the media item or other relevant information contained in a remote system.

For example, if an analysis of sequential CVC/CDS blocks shows a break in the chain of hashes (e.g., CDC#2 contains a hash of CDC#1 and is cryptographically signed, but CDC#3 does not contain a proper hash of CDC#2, etc.), the discrepancy may be noted and/or factored into a final output as to whether the media item is reliable.

At act 558, any other information may be analyzed for consistency with the media item, information contained in a remote system and/or any other data source.

Any discrepancy may be noted and/or factored into a final output as to whether the media item is reliable.

At act 560, the process ends.

The comparison of the corroborating data set encoded and signed or encrypted in the cryptographic verification code to the attributes of the media may be conducted by traditional, artificial intelligence/neural network, or any other comparison technique(s) or combinations thereof.

With reference to FIG. 5C, an overview of an example media attribute feature analyzer is depicted. An item of information (e.g., the time, the orientation, the ambient audio spectrum, any of the acts or information items discussed above with respect to FIG. 5B, etc.) is extracted from a corroborating data set 570 and input into a feature analyzer 576 along with corresponding media depiction information 572. Optionally, a prior determination 574 from the output of the feature analyzer 576 may also be used as an input to the feature analyzer 576. With the provided inputs, the feature analyzer 576 uses traditional or artificial intelligence techniques to determine and output a feature authenticity score or determination 578.

There may be many different feature analyzers 576 employed individually or in parallel in different forms of the disclosure. These different feature analyzers may be used to analyze different information types in the corroborating data set and analyzed media files. The output from these parallel feature analyzers may be fed into a media analyzer.

With reference to FIG. 5D, an overview of an example media analyzer is depicted. A feature authenticity score or determination 578 from a feature analyzer 576 is input into a media analyzer 580. Other inputs 579 (e.g., other feature authenticity scores or determinations from other feature analyzers, other data inputs, etc.) may also be input into media analyzer 580. With the provided inputs, the media analyzer 580 uses traditional or artificial intelligence techniques to determine and output a media authenticity score or determination 582.

With any of the comparison techniques, the devices systems and methods herein may account for the lag time between an event depicted in a media item, and the time it takes the token device hardware to sense the near-real time information and create a CDS, cryptographically sign the information, convert the CDS into a CVC, and display/emit/broadcast a representation of the CVC.

Using a media authenticity score or determination 582, the user can be notified as to whether or not any particular item of media is reliable. Using a feature authenticity score or determination 578, more detail about why a particular media item may or may not be reliable can be communicated to a media viewer. This information can be utilized in end-user applications, media viewing applications, social media, and other platforms in order to provide better and more reliable information to end users.

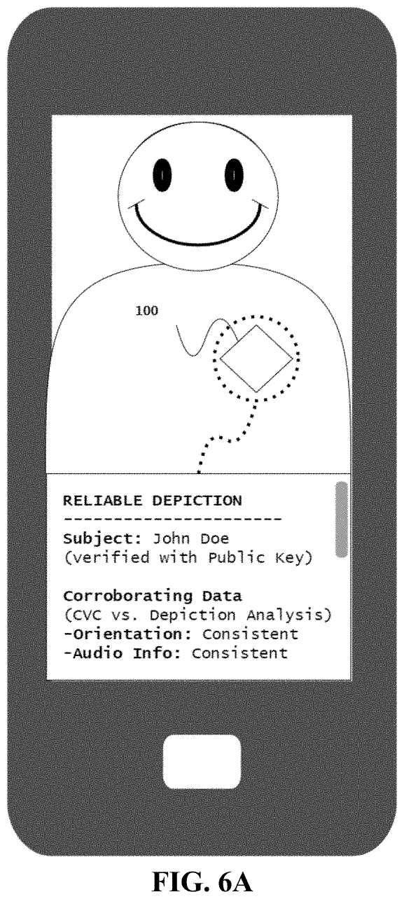

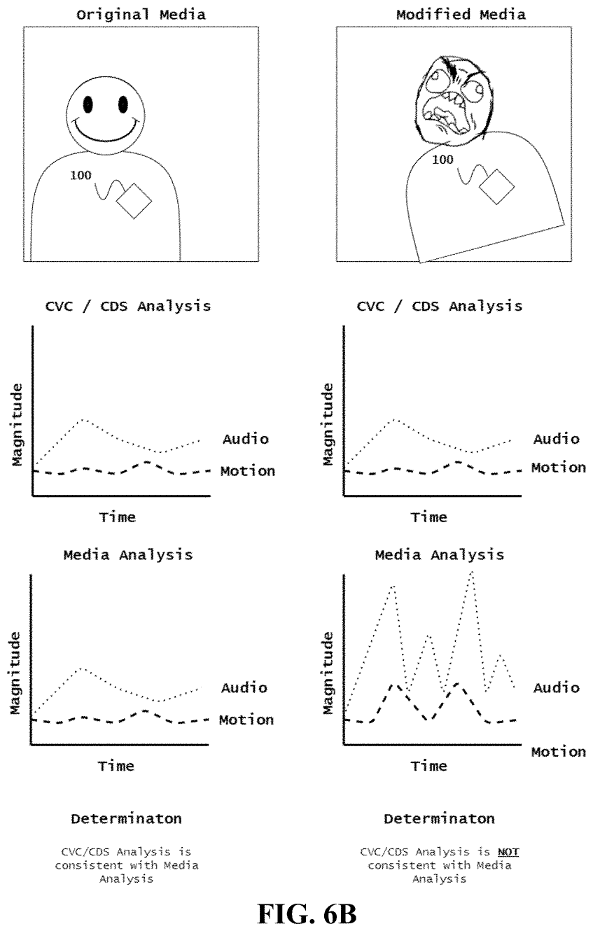

IV.A. Verifying Media Against Depicted CVC. With reference to FIG. 6A, an example verification of a media item is shown.

For purposes of illustration and without limitation of any claimed invention, a totem device 100 is worn by a media subject. A third party with a mobile device is able to analyze a cryptographic verification code displayed on the totem device 100 in the media. Using the cryptographic verification code, the third party's mobile device is able to determine if the code is properly signed by the purported subject, and whether or not the contained corroborating data is consistent with the depiction in the media. The mobile device may be configured to show a dialog or other user interface item or indication with additional information about the subject of the media (e.g., John Doe (verified with public key and cryptographic signature)) and corroborating data (the orientation of the device as determined from an analysis of the media is consistent with the information cryptographically signed by the media subject; the audio information in the video is consistent with the audio information cryptographically signed by the media subject).

With reference to FIG. 6B, for purposes of illustration and without limitation of any claimed invention, an example media analysis according to one form of this aspect of the disclosure is illustrated.

In an item of original unmodified video media (left column), the subject wears totem device 100. Similarly, in an item of modified video media (right column), the subject wears totem device 100.

The analysis of the CVC and CDS throughout the various frames of the video media content confirms the identity of subject using private key. If the CVC/CDS data in the media has been obscured or unreadable, a message stating that the video cannot be verified may be shown. If it is determined that the CVC/CDS has deliberately been blurred or damaged it may be noted and advised that the damage may be intentional to conceal modifications that have been made.

A further analysis of the CVC/CDS may confirm that the timeline is untouched and that the CVC and CDS depicted in the video are sequential. If there is an issue with the timeline, a warning may be given to a viewer of the media that the video has been cut and selectively edited because the time stamps depicted in the CVC have gaps/the hash chain is not linked in the displayed video/etc.

A timeline of corroborating information extracted from the CVC/CDS (e.g., audio and motion, etc.) can be created in the memory of a device analyzing the media.

An analysis of the audio and motion of the subject in the media can also be conducted. A similar timeline of media attributes for corresponding features (e.g., audio and motion, etc.) may be created in the memory of the device analyzing the media.

Comparing the two sets of information a determination can be made. In the lower left column, the media analysis is consistent with the CVC/CDS analysis. A determination that the video is consistent with the totem may be shown. In the lower right column, the media analysis is not consistent with the CVC/CDS analysis. A viewer of the media may be alerted as to the potential untrustworthiness of the video and the specific reasons for that determination.

Alert: The audio extracted from the media and the audio information encoded in the CVC/CDS do not match (shown in the lower right column)

Alert: The motion/orientation information inferred from an analysis of the subject in the media does not match the motion/orientation information in the CVC/CDS.

Example Using Phone QR Code Scanner, Ethereum Message Verifier. With reference to FIG. 7A, first, an image of a cryptographic verification code is captured from media or directly from a totem device 100. This may be done using, for example, a smart phone using a QR code scanning application. With reference to FIG. 7B, the data in the displayed cryptographic verification code is decoded. This may be done using, for example, a smart phone using a QR code scanning application. The data may include a Corroborating Data Set (CDS) with various information and a cryptographic message signature as shown below.

In this example, a corroborating data set was collected by a device containing a private key associated with the following Ethereum address:
0x48A548CD7DE5a84F3e56ADB1e98c5C0F5872E6Bb.

The corroborating data set contains an NFT tokenID number, the date, the time, the instantaneous acceleration in the X Y and Z axes, an FFT from roughly 300 Hz to 6000 Hz in roughly 200 Hz intervals where the intensity is from 0 to 9. The resulting CDS is:
CDS: 1 04-17-2021 16:16:18 -756 94 -735 100000110000000000000000

The components of the CDS can be decoded as shown in the following Table:

| | |
|---|---|
| 1 | The NFT tokenID number associated |
| | with this user/device in the Ethereum |
| | smart contract backend |
| Apr. 17, 2021 | The Date the corroborating data set was |
| | produced |
| 16:16:18 | The time the corroborating data set was |
| | produced |
| −756 | The X component of acceleration in the |
| | axes of the watch/accelerometer chip |
| 94 | The Y component of acceleration in the |
| | axes of the watch/accelerometer chip |
| −735 | The Z component of acceleration in the |
| | axes of the watch/accelerometer chip |
| 100000110000000000000000 | The audio spectrum intensity. Output |
| | number position from left to right. The |
| | higher number the higher the detected |
| | sound amplitude. |
| | 01)~300-500 Hz |
| | 02)~700 Hz |
| | 03)~900 Hz |
| | 04)~1100 Hz |
| | 05)~1300 Hz |
| | 06)~1500 Hz |
| | 07)~1600 Hz |
| | 08)~2000 Hz |
| | 09)~2200 Hz |
| | 10)~2400 Hz |
| | 11)~2600 Hz |
| | 12)~2800 Hz |
| | 13)~3000 Hz |
| | 14)~3200 Hz |
| | 15)~3400 Hz |
| | 16)~3600 Hz |
| | 17)~3900 Hz |
| | 18)~4000 Hz |
| | 19)~4200 Hz |
| | 20)~4500 Hz |
| | 21)~4700 Hz |
| | 22)~4900 Hz |
| | 23)~5200 Hz |
| | 24)~5500 Hz |

The corroborating data set was then hashed using the KECCAK256 hashing algorithm and signed using the SECP256k1 algorithm and the private key associated with the above Ethereum address. The following signature was produced:
0x51cfc228f28786034396bd384ebcaaa3f41daf7c34b33ce767572ef26bee1ad65dd5996c5 d0688f5148a776fc819bb27a5b10f30094da3fd69e30df5e740b3761b

This signature is combined with the corroborating data set to produce a cryptographic verification code:
CDS: 1 04-17-2021 16:16:18 -756 94 -735 100000110000000000000000 SIG: 0x51cfc228f28786034396bd384ebcaaa3f41daf7c34b33ce767572ef26bee1ad65dd5996c5 d0688f5148a776fc819bb27a5b10f30094da3fd69e30df5e740b3761b

This cryptographic verification code was then converted into the QR code image shown above using QR version 9 and low ECC to fit the data on the particular display of the prototype device. To the extent possible, a larger display or lower density version QR code and higher ECC correction would be preferable.

With the above code, the cryptographic verification process can occur.

The CDS and message signature can be used to recover the public address of the person who created the message signature with their private key. The message signature can be verified as coming from a known private key using the example NFT smart contract function above:
cvcIsValidFromMsgStr(string memory_message, bytes memory_signature, uint64 tokenld)

For example, in this case, the function call would be filled in as follows:

cvcIsValidFromMsgStr(
“CDS: 1 04-17-2021 16:16:18 -756 94 -735
100000110000000000000000 “,
“0x51cfc228f28786034396bd384ebcaaa3f41daf7c34b33ce767572ef2
6bee1ad65dd5996c5d0688f5148a776fc8f9bb27a5b10f30094da3fd69e
30df5e740b3761b”, 1)

If the signature is valid and associated with the correct tokenId, then the above function will return TRUE. If not, it will return FALSE.

With reference to FIG. 7C, alternatively, a public website such as http://etherscan/io/verifySig can be used to verify the signature and message is associated with a specific public Ethereum address. (Shown below with information from the example above).

After the CVC is validated, the media can be analyzed for consistency with the CDS contained within the CVC.

Computer code for example react frontend (depicted in FIGS. 7D-7G) to the Ethereum smart contract (provided in Code Listings 8-10) that can be used to verify a cryptographic verification code is provided in the Code Appendix as Code Listing 11.

IV.B. Verify Media Against Third Party CVC. In some forms of this aspect of the disclosure, third party CVCs containing corroborating information may also be used to verify media.

For example, CVCs/CDSs of third parties within the captured media (e.g., other people in the media, etc.) may be analyzed for consistency with the CVC/CDS displayed by the primary subject to the extent there is overlapping data provided in their CDS.

As another example, relevant CVCs not from the captured media but obtained from a back end based on CVC/CDS information about nearby people obtained from a CVC/CDS captured in a video. (e.g., a person whose totem ID is in the environmental information of a CVC/CDS captured in the media, a person who was very near the person depicted in the video at the same time, etc.)

V. Media Viewer Applications. In some forms of the disclosure, image and video viewing software may be used to automatically flag and verify inconsistencies in the coded data.

V.A. User Interface and Display Features. For purposes of illustration and without limitation of any claimed invention, media viewing software may recognize objects (e.g., people, etc.) in the media, and annotate those objects (e.g., people, etc.) in different ways depending on whether: (a) a cryptographic verification code worn or placed on the object is properly signed and (b) whether the corroborating data set is consistent with the media content.

For example, if the CVC is properly signed and the CDS is consistent with the media, the person may have a green annotation. If a CVC is not properly signed and/or the CDS is inconsistent with the media, then the person may have a yellow or red annotation.

For example, if a CVC does not properly decode (or does not properly decode for a lengthy period of time in the media, or that decode with inconsistent or corrupt information, etc.), then an annotation may be added to note that there is an issue with the CVC.

In some forms of the disclosure, media viewing software may “repair” the media to replace a CVC/CDS that is properly signed and consistent with the media content with a replacement image to make the video look “normal” again.

For example, media viewing software may overlay or annotate replacement images or data over the CVC to remove the totem device from the depiction in the video. For purposes of illustration and without limitation of any claimed invention, if the totem is placed on a hat, then the media viewing software may replace a totem displaying a proper and consistent CVC/CDS with a sports team logo specified by the user. A viewer of the media would see a “normal” hat with a sports team logo after the media viewing software verified the CVC/CDS and “remastered” the media with the replacement image/annotation on the hat. A deep neural network can be used to “fake” the implantation of the logo to make it look authentic after verifying the image with the encoded image and metadata.

In some forms of the disclosure, media viewing software may also compare a CVC/CDS in the media with other captured CVC/CDS data from a backend system. CVC/CDS data may be filtered on the backend system to determine such information that was captured in other media files at the same time nearby to compare cellular towers, Wi-Fi access point information, other nearby users, etc. to help further corroborate and strengthen the confidence that can be placed in the authenticity of the media item.

V.B. Social Media Permissions. In some forms of the disclosure, social media platforms that allow users to upload media may implement a permissions system based on detected CVC/CDS data in the uploaded media.

For example, social media platforms may use the CVC/CDS data to verify the identity of a subject in media uploaded by other users to the platform. Based on the decoded CVC/CDS data and the confirmed identity, the social media platform may allow the subject of the media (that was uploaded by a third party) to approve or deny the media posting, retroactively remove the posting, or remove the image of the user from the media using other techniques (e.g., deep neural networks to remove the user from the photo as if the user was never in the photo to begin with).

V.C. Video Sharing Website Fake News Blocking. In some forms of the disclosure, video media platforms that allow users to upload media may implement a permissions system based on detected CVC/CDS data in the uploaded media.

For example, video media platforms such as YouTube may use the CVC/CDS data to verify the authenticity of segments of media uploaded by other users to the platform. Based on the decoded CVC/CDS data and an analysis of the consistency of the media with the CDS, the social media platform may block the posting of manipulated media.

For purposes of illustration and without limitation of any claimed invention, if a third party takes a CNN video segment on a topic (that includes a CVC/CDS) and produces a commentary on the CNN video segment interspersing segments of the CNN video with the commentary, so long as the CVC/CDS corresponds correctly to the CNN video segment the platform may allow the distribution of the third party commentary media.

However, For purposes of illustration and without limitation of any claimed invention, if a third party takes a CNN video segment on a topic (that includes a CVC/CDS) and produces a commentary on the CNN video segment interspersing segments of the CNN video with the commentary but also modifies the CNN content with deep fake techniques, the video media platform may detect the CVC/CDS no longer corresponds correctly to the CNN video segment and the platform may prevent the distribution of the third party commentary media.

V.D. Media Licensing. In some forms of the disclosure, media may be identified and authenticated based on the CVC/CDS. This identification may be used in the licensing of the video. The licensing of the media may be done using a Non-Fungible ERC721 or a Fungible ERC20 Token.

VI. Other Applications for CDS and CVC. There are numerous additional applications for corroborating data sets and cryptographic verification codes. For purposes if illustration and without limitation, examples are provided below.

VI.A. Cryptographic Verification Codes Affixed to Items. For example, a cryptographic verification code may be a single use code that is placed on a real-world item to verify the authenticity of the information displayed on, or characteristics of, the item.

Currency Counterfeit Prevention. For example, the United States Mint may create a corroborating data set for each dollar bill and coin minted. The corroborating data set may include information about the currency (e.g., date/time the currency was minted, the value of the currency, the serial number of the bill or coin, etc.). The corroborating data set can then be cryptographically signed or encrypted to create a cryptographic verification code. The code is signed by a private key associated with a public key known to belong to the United States government. Later parties interested in verifying the authenticity of the bill can utilize the cryptographic verification code to confirm that the item is genuine, issued by the U.S. government, and that the bill is what it purports to be. If a particular CVC is copied and used on a counterfeit bill or coin, then that particular CVC can be flagged as suspect and other counterfeit prevention techniques can be used to determine the true owner of that bill and provide a replacement bill that does not have a compromised CVC. Thus, a counterfeiter would need to have access to a large number of official CVC codes to make counterfeit money that would not be quickly disabled.

Collectible Confirmation. For example, a basketball player may create a corroborating data set for a championship jersey that is sold at auction. The corroborating data set may include information about the jersey such as a text description of its significant, important dates associated with the jersey, creation time of the code, and a dedication to the purchaser. The corroborating data set can then be cryptographically signed or encrypted to create a cryptographic verification code. The code is signed by the basketball player or an entity such as the basketball team. Later parties interested in verifying the authenticity, or anyone that views a picture or a video of the item, can utilize the cryptographic verification code to confirm that the item is genuine and what it purports to be.

Tamper Resistant Human and Machine Readable and Verifiable Information. For example, machines such as self-driving cars may be programmed to only recognize road signs that have an encrypted cryptographic verification code signed by an authority with jurisdiction to place road signs. Many cars, such as Tesla cars, have been tricked into driving at excessive speeds (e.g., 85 mph) instead of posted speeds (e.g., 35 mph) when people have modified road signs with tape. A single corroborating data set can be generated by a municipality or entity in charge of roadways for a road sign. The corroborating data set may include the date and time created, and the content displayed on the sign (e.g., STOP, 35 mph, YIELD, WRONG WAY, etc.). This corroborating data set may be encrypted to create a cryptographic verification code. The cryptographic verification code may be printed of otherwise affixed to the sign. Self-driving cars can then read the sign, and cryptographically verify that the sign has not been tampered with.

If the sign has been tampered with, a notification can be sent to the entity in charge of the road sign to correct the issue.

May Be Dynamic Codes. Any of the above examples may have a (simple) totem device 100 instead of a fixed printing of a CVC. The totem device can be a low power device with a relatively low update frequency or on demand update frequency. The device may create a CDS with the current time, information about the item, and/or a reference to an NFT token Id associated with the private key associated with the item. A user seeking to verify the authenticity of the item to which the totem is affixed may (optionally manually request an updated CVC/CDS and then) scan the affixed CVC/CDS to verify the item.

VI.B. Use as a Multi-Factor Authentication Device. In some forms of the disclosure, the totem device and the CVC/CDS may be used as a multi-factor authentication device.

For purposes of illustration and without limitation of any claimed invention, a remote system with a user account may store a list of authorized user public keys or public Ethereum addresses. To access the account, a user may use a camera on their mobile device to capture the current CVC displayed by their totem and send it to the remote system. Upon verifying the CVC and the included CDS with the current time (and optionally an additional password that the user also provides), the remote system may provide the user access to their account.

For purposes of illustration and without limitation of any claimed invention, supercars or other machinery may maintain a list of authorized user public keys or Ethereum addresses. The machine may have a camera, microphone, and/or other interface for capturing CVCs from the individual that is positioned to operate the machine (e.g., in the case of a car the individual in the driver seat, etc.). This interface is configured to observe the CVC over time. The machine ensures that the CVC of the operator matches an authorized user on an ongoing basis.

The machine may also use other sensors to ensure that the CDS extracted from the CDS is consistent with what is happening in the car.

As an illustrative example, the machine may play a random sound over its speaker system and observe that the encoded CVC/CDS contains the proper frequency spectrum in a subsequent signed message.

VI.C. Real-Time Physical Verification. In some forms of this aspect of the disclosure, a third-party may verify a totem device in real time by causing the totem device to process information supplied by the third party to ensure that the result could not have been generated ahead of time.

VI.C.1. Via Real World Third-Party Influencing of the Totem's CDS.

In some forms of this aspect of the disclosure, a third-party may emit a sound or other item of information near someone wearing the totem device to verify the individual has a real totem device.

For purposes of illustration and without limitation of any claimed invention, when verifying an acquaintance in real life, the totem of a wearer may be used in conjunction with a mobile verification app by a third-party to ensure that the wearer's totem is authentic.

As an example, a third-party may have a verification application on a mobile device configured to: (1) emit a random sound frequency spectrum; (2) observe the CVC of a totem (e.g., a QR code displayed on the face of the totem device) using a camera of the mobile device; (3) verify that a CVC/CDS displayed on the totem device contains the proper frequency spectrum in a subsequent signed message.

As another example, a third-party may have a verification application on a mobile device configured to: (1) observe the CVC of a totem (e.g., a QR code displayed on the face of the totem device) using a camera of the mobile device where the CVC/CDS of the totem is configured to contain information such as the MAC addresses of nearby devices (such as the Wi-Fi or Bluetooth address of the mobile device); (2) verify that a CVC/CDS displayed on the totem device contains the MAC address of the mobile device in a subsequent signed message.

VI.C.2. Via Network Transaction. In some forms of this aspect of the disclosure, a third-party may send an Ethereum transaction to an address of someone wearing the totem device to verify the individual. The totem device may pull the transaction from the Ethereum network and incorporate the transaction into a corroborating data set. The third party can then verify the corroborating data set in real life and in real time as containing the information contained in their message to the wearer of the device and signed by their private key.

For purposes of illustration and without limitation of any claimed invention, when verifying an acquaintance in real life, the totem of a wearer may be used in conjunction with a mobile verification app by a third-party to ensure that the wearer's totem is authentic.

As an illustrative example, a third-party may have a verification application on a mobile device configured to:

First, Obtain the public address of the totem wearer. For example: (1) scan the CVC/CDS; (2) extract an NFT tokenId from the CDS; (3) Obtain the public address from the NFT tokenId after querying the appropriate smart contract on the Ethereum network; (4) optionally verify that the CVC is properly signed. Next, send a transaction to the public address of the totem wearer. Then, observe the CVC of a totem (e.g., a QR code displayed on the face of the totem device) using a camera of the mobile device, where the CVC of the totem is configured to include a CDS with recent transaction information from the Ethereum network obtained via a wireless network connection. Subsequently, verify that a CVC/CDS displayed on the totem device contains the proper transaction information from the third-party.

VII. Conclusion.

As those skilled in the art will appreciate, many aspects of the invention, and the various forms of the invention, can beneficially be practiced alone and need not be coupled together. Unless specifically stated otherwise, no aspect of the invention should be construed as requiring combination with another aspect of the invention in practice. However, those skilled in the art will also appreciate that the aspects of the invention may be combined in any way imaginable to yield one of the various forms of this invention.

Various alterations and changes can be made to the above-described embodiments without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

I claim:

1. A device comprising: a processor, a memory, a microphone, and a display;
wherein the processor is configured to:
1) use the memory to store a private key, and
2) use the microphone to collect near real-time ambient audio information;
3) use the processor to generate a corroborating data set including information based on at least the time and the collected audio information;
4)use the processor and memory to cryptographically sign the corroborating data set with the stored private key to produce cryptographic verification code, and
5) use the display to show the cryptographic verification code.

2. The device of claim 1, wherein the processor is configured to generate a corroborating data set from the audio information using a Fast Fourier transform to provide amplitude and frequency information.

3. The device of claim 2 wherein the processor is configured to hash the corroborating data set using the KECCAK256 algorithm.

4. The device of claim 3 wherein the processor is configured to produce a signature of the corroborating data set hash by cryptographically signing it with the private key using the SECP256k1 ECDSA algorithm.

5. The device of claim 4 wherein the cryptographic verification code is created by the processor using the corroborating data set and the corroborating data set cryptographic signature.

6. The device of claim 5 wherein the cryptographic verification code is formatted into an optical code for the display.

7. The device of claim 6 wherein the optical code is a QR code.

8. A device comprising: a processor, a memory, a microphone, and a speaker;
wherein the processor is configured to:
1) use the memory to store a private key, and
2) use the microphone to collect near real-time ambient audio information;
3) use the processor to generate a corroborating data set including information based on at least the time and the collected audio information;
4) use the processor and memory to cryptographically sign the corroborating data set with the stored private key to produce cryptographic verification code, and
5) use the speaker to emit the cryptographic verification code.

9. The device of claim 8 wherein the processor is configured to generate a corroborating data set from the audio information using a Fast Fourier transform to provide amplitude and frequency information.

10. The device of claim 9 wherein the processor is configured to hash the corroborating data set using the KECCAK256 algorithm.

11. The device of claim 10 wherein the processor is configured to produce a signature of the corroborating data set hash by cryptographically signing it with the private key using the SECP256k1 ECDSA algorithm.

12. The device of claim 11 wherein the cryptographic verification code is created by the processor using the corroborating data set and the corroborating data set cryptographic signature.

13. The device of claim 12 wherein the cryptographic verification code is formatted into a sub-audible sound for emission from the speaker of the device.

14. A device comprising: a processor, a memory, a microphone, a camera, a display, and a speaker;
wherein the processor is configured to:
1) use the memory to store a private key, and
2) while collecting near real-time ambient audio information from the camera and microphone to stream or create a media file:
a) generate a corroborating data set including information based on at least the time and the collected audio and/or video information;
b) cryptographically sign (or encrypt) the corroborating data set with the stored private key to produce cryptographic verification code; and,
c) overlay or embed the cryptographic verification code on or within the streamed or created media file.

15. The device of claim 14 wherein the processor is configured to generate a corroborating data set from the audio information using a Fast Fourier transform to provide amplitude and frequency information.

16. The device of claim 14 wherein the processor is configured to hash the corroborating data set using the KECCAK256 algorithm.

17. The device of claim 16 wherein the processor is configured to produce a signature of the corroborating data set hash by cryptographically signing it with the private key using the SECP256k1 ECDSA algorithm.

18. The device of claim 17 wherein the cryptographic verification code is created by the processor using the corroborating data set and the corroborating data set cryptographic signature.

19. The device of claim 18 wherein the cryptographic verification code is formatted into an optical code that is overlaid or embedded into the media file.

20. The device of claim 19 wherein the optical code is a QR code.
